(19) United States
(12) Patent Application Publication
(10) Pub. No.: US 2023/0071372 A1
(43) Pub. Date: Mar. 9, 2023

(54) DETECTION AND COMPENSATION OF OBSERVED SIGNAL POWER OFFSETS DUE TO ATTENUATION OR AMPLIFICATION CAUSED BY MOBILE STRUCTURES

(71) Applicant: HERE Global B.V., Eindhoven (NL)

(72) Inventors: Petri Rauhala, Tampere (FI); Henri Jaakko Julius Nurminen, Tampere (FI); Mike Koivisto, Tampere (FI)

(21) Appl. No.: 17/469,522

(22) Filed: Sep. 8, 2021

(51) Int. Cl. H04W 64/00; H04B 17/26; H04B 17/318; G01S 5/02

(52) U.S. Cl. CPC H04W 64/006; H04B 17/26; H04B 17/318; G01S 5/02521

(57) ABSTRACT

A computing device obtains an instance of radio observation data and an associated circumstance parameter. The instance of radio observation data indicates an observed signal strength a radio node observed by a mobile device. The circumstance parameter indicates a characteristic of motion of the mobile device and/or a characteristic of the environment about the mobile device when the instance of radio observation data was captured. The computing device determines a context associated with the instance of radio observation data based at least in part on the circumstance parameter; determining a context-specific signal strength correction based at least in part on the context; generates a corrected signal strength of the radio node based on the observed signal strength and the signal strength correction; and generates and/or updates a radio map based at least in part on the corrected signal strength of the at least one radio node.

### TECHNOLOGICAL FIELD

An example embodiment relates to detecting and/or compensating observed signal power offsets caused by attenuation or amplification corresponding to a mobile structure. An example embodiment relates to generating a radio map based on detected and/or compensated observed signal power offsets caused by attenuation or amplification corresponding to a mobile structure. An example embodiment relates to using a detected and/or compensated observed signal power offset when using a radio map.

### BACKGROUND

Radio-based positioning is a form of positioning where the radio signals observed by a device and/or characteristics describing the radio signals observed by a device are used to determine a position estimate for the device. In particular, the position estimate for the device is determined based on a known location of the radio nodes that generated the observed radio signals and/or radio models that describe the coverage areas of the radio nodes that generated the observed radio signals. In some scenarios, the known location of the radio nodes and/or the radio models for the radio nodes are determined based on crowd-sourced data. However, some of the crowd-sourced data may be captured by computing devices located within mobile structures (e.g., temporary buildings or structures, vehicles or structures related to modes of transportation, and/or the like). This may lead to an artificially wide dispersion or statistical spread in the observed signal strength values used to determine the known location of a radio node or a radio model for the radio node, which may lead to positioning errors and/or a lack of positioning accuracy.

### BRIEF SUMMARY

Various embodiments provide methods, apparatus, systems, and computer program products for correcting observed radio signal characteristics for effects caused by observing the radio signals from within a mobile structure. Various embodiments provide methods, apparatus, systems, and computer program products for generating radio maps based on radio observation data that has been corrected for the effects caused by observing radio signals from within a mobile structure. Various embodiments provide methods, apparatus, systems, and computer program products for utilizing radio observation data that has been corrected for the effects caused by observing radio signals from within a mobile structure when using a radio map to perform positioning and/or navigation-related functions.

In various scenarios, when a mobile device or computing entity observes radio signal from within a mobile structure, the mobile structure may cause the observed signal to be attenuated (with respect to a nearby position located just outside the mobile structure or with respect to the same position when the mobile structure is not present). In various scenarios, the mobile structure may include a signal repeater or other amplifier that causes the observed radio signal within the mobile structure to be amplified (with respect to a nearby position located just outside the mobile structure or with respect to the same position when the mobile structure is not present). Thus, when a mobile device or computing entity observes the radio signal at a position within the mobile structure, there is an offset between observed characteristics of the radio signal (e.g., the observed signal strength) and the signal strength of the radio signal at the same position when the mobile structure is not present at the position.

In various embodiments, a sequence of instances of radio data are obtained, processed, and/or analyzed. The instances of radio data of the sequence of instances of radio data include associated respective instances of radio observation data, instances of location data, and circumstance parameters. In various embodiments, an instance of radio observation data characterizes the observation of one or more radio signals by the mobile device that captured the instance of radio data. In various embodiments, an instance of location data indicates a position estimate of the mobile device when the mobile device captured the corresponding instance of radio observation data (e.g., observed the radio signals characterized by the instance of radio observation data). In various embodiments, a circumstance parameter characterizes the motion state and/or at least a portion of the environment about the mobile device when the mobile device captured the corresponding instance of radio observation data. A context under which an instance of radio data is determined based on the respective instance of location data and/or circumstance parameter. In various embodiments, the context under which an instance of radio observation data was captured indicates at least one of (a) a mobility state of the mobile device when the instance of radio observation data was captured or (b) a type of mobile structure that the mobile device was located within when the instance of radio observation data was captured. A signal characteristic correction (e.g., a signal strength correction) corresponding to the context is determined and corrected signal characteristics corresponding to one or more instances of radio observation data captured under the same context may be generated based on the determined signal characteristic correction.

In various embodiments, a radio map is generated and/or updated based on the corrected signal characteristics. In various embodiments, the radio map is used to perform positioning and/or navigation-related functions. In various embodiments, context-specific corrections may be tracked and/or determined for use when using the radio map to perform positioning and/or navigation-related functions.

In an example embodiment, a computing device, such as a network device, obtains an instance of radio observation data and at least one associated circumstance parameter. The instance of radio observation data indicates an observed signal strength of at least one radio node observed by a mobile device. The at least one associated circumstance parameter indicates at least one of a characteristic of motion of the mobile device or a characteristic of at least a portion of the environment about the mobile device when the instance of radio observation data was captured. The computing device determines a context associated with the instance of radio observation data based at least in part on the circumstance parameter; determines a context-specific signal strength correction based at least in part on the context; generates a corrected signal strength of the at least one radio node based on the observed signal strength of the at least one radio node and the context-specific signal strength correction; and, based at least in part on the corrected signal strength of the at least one radio node, (i) determines at least one position of the mobile device and/or (ii) generates and/or updates a radio map.

In an example embodiment, a computing device, such as a network device, obtains a plurality and/or time-ordered sequence of instances of radio data generated by a mobile device. The plurality and/or time-ordered sequence of instances of radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data. Each instance of radio observation data of the plurality of instances of radio observation data indicates a respective observed signal strength of a respective at least one radio node. Each respective instance of location data of the plurality of instances of location data indicates a respective location of the mobile device when the mobile device captured an associated instance of radio observation data. Each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data. The plurality and/or time-ordered sequence of instances of radio data comprises a first instance of radio observation data associated with a first instance of location data and a first circumstance parameter. The first instance of radio observation data indicates a first observed signal strength of at least one first radio node at a first location indicated by the first instance of location data while the mobile device was at least one of moving with a characteristic of motion and/or experiencing an environment indicated by the first circumstance parameter. The computing device determines a first context indicating a context under which the first instance of radio observation data was captured based on at least one of the first circumstance parameter or the first location. The computing device determines a reference signal strength of the at least one first radio node at the first location based at least on the first location. The computing device determines a first signal strength correction corresponding to the first context based on the reference signal strength and the first observed signal strength of the at least one first radio node. The computing device generates one or more corrected signal strengths by adjusting one or more observed signal strengths of the plurality instances of radio observation data respectively associated with the first context using the first signal strength correction. Each corrected signal strength of the one or more corrected signal strengths is associated with a respective instance of location data of the plurality of instances of location data.

In one aspect of the present disclosure, a method for generating and/or determining corrected signal strengths is provided. In various embodiments, the method is performed by a computing device, such as a network device. In an example embodiment, the method comprises obtaining an instance of radio observation data and at least one associated circumstance parameter. The instance of radio observation data indicates an observed signal strength of at least one radio node observed by a mobile device. The at least one associated circumstance parameter indicates at least one of a characteristic of motion of the mobile device or a characteristic of at least a portion of the environment about the mobile device when the instance of radio observation data was captured. The method further comprises determining a context associated with the instance of radio observation data based at least in part on the circumstance parameter; determining a context-specific signal strength correction based at least in part on the context; generating a corrected signal strength of the at least one radio node based on the observed signal strength of the at least one radio node and the context-specific signal strength correction; and based at least in part on the corrected signal strength of the at least one radio node, (i) determining at least one position of the mobile device and/or (ii) generating and/or updating a radio map.

In another aspect of the present disclosure an apparatus (e.g., a computing device such as a network device) is provided. In an example embodiment, the apparatus comprises at least one processor and at least one memory storing computer program code and/or instructions. The at least one memory and the computer program code and/or instructions are configured to, with the processor, cause the apparatus to at least obtain an instance of radio observation data and at least one associated circumstance parameter. The instance of radio observation data indicates an observed signal strength of at least one radio node observed by a mobile device. The at least one associated circumstance parameter indicates at least one of a characteristic of motion of the mobile device or a characteristic of at least a portion of the environment about the mobile device when the instance of radio observation data was captured. The at least one memory and the computer program code and/or instructions are further configured to, with the processor, cause the apparatus to at least determine a context associated with the instance of radio observation data based at least in part on the circumstance parameter; determine a context-specific signal strength correction based at least in part on the context; generate a corrected signal strength of the at least one radio node based on the observed signal strength of the at least one radio node and the context-specific signal strength correction; and based at least in part on the corrected signal strength of the at least one radio node, (i) determine at least one position of the mobile device and/or (ii) generate and/or update a radio map.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to obtain an instance of radio observation data and at least one associated circumstance parameter. The instance of radio observation data indicates an observed signal strength of at least one radio node observed by a mobile device. The at least one associated circumstance parameter indicates at least one of a characteristic of motion of the mobile device or a characteristic of at least a portion of the environment about the mobile device when the instance of radio observation data was captured. The computer-readable program code and/or instructions portions comprise executable portions further configured, when executed by a processor of an apparatus, to cause the apparatus to determine a context associated with the instance of radio observation data based at least in part on the circumstance parameter; determine a context-specific signal strength correction based at least in part on the context; generate a corrected signal strength of the at least one radio node based on the observed signal strength of the at least one radio node and the context-specific signal strength correction; and based at least in part on the corrected signal strength of the at least one radio node, (i) determine at least one position of the mobile device and/or (ii) generate and/or update a radio map.

According to yet another aspect, an apparatus is provided. In an example embodiment, the apparatus comprises means for obtaining an instance of radio observation data and at least one associated circumstance parameter. The instance of radio observation data indicates an observed signal strength of at least one radio node observed by a mobile device. The at least one associated circumstance parameter indicates at least one of a characteristic of motion of the mobile device or a characteristic of at least a portion of the environment about the mobile device when the instance of radio observation data was captured. The apparatus comprises means for determining a context associated with the instance of radio observation data based at least in part on the circumstance parameter. The apparatus comprises means for determining a context-specific signal strength correction based at least in part on the context. The apparatus comprises means for generating a corrected signal strength of the at least one radio node based on the observed signal strength of the at least one radio node and the context-specific signal strength correction. The apparatus comprises means for, based at least in part on the corrected signal strength of the at least one radio node, (i) determining at least one position of the mobile device and/or (ii) generating and/or updating a radio map.

According to an aspect of the present disclosure, a method for generating and/or determining corrected signal strengths is provided. In various embodiments, the method is performed by a computing device, such as a network device. In an example embodiment, the method comprises obtaining a plurality and/or time-ordered sequence of instances of radio data generated by a mobile device. The plurality and/or time-ordered sequence of instances of radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data. Each instance of radio observation data of the plurality of instances of radio observation data indicates a respective observed signal strength of a respective at least one radio node. Each respective instance of location data of the plurality of instances of location data indicates a respective location of the mobile device when the mobile device captured an associated instance of radio observation data. Each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data. The plurality and/or time-ordered sequence of instances of radio data comprises a first instance of radio observation data associated with a first instance of location data and a first circumstance parameter. The first instance of radio observation data indicates a first observed signal strength of at least one first radio node at a first location indicated by the first instance of location data while the mobile device was at least one of moving with a characteristic of motion and/or experiencing an environment indicated by the first circumstance parameter. The method further comprises determining a first context indicating a context under which the first instance of radio observation data was captured based on at least one of the first circumstance parameter or the first location. The method further comprises determining a reference signal strength of the at least one first radio node at the first location based at least on the first location. The method further comprises determining a first signal strength correction corresponding to the first context based on the reference signal strength and the first observed signal strength of the at least one first radio node. The method further comprises generating one or more corrected signal strengths by adjusting one or more observed signal strengths of the plurality instances of radio observation data respectively associated with the first context using the first signal strength correction. Each corrected signal strength of the one or more corrected signal strengths is associated with a respective instance of location data of the plurality of instances of location data.

In an example embodiment, the method further comprises generating or updating a radio map based on the one or more corrected signal strengths and the associated respective instances of location data; and storing and/or providing the radio map for at least use in performing one or more positioning and/or navigation-related functions.

In an example embodiment, the radio map is specific to the first context.

In an example embodiment, the context under which the first instance of radio observation data was captured indicates at least one of (a) a mobility state of the mobile device when the first instance of radio observation data was captured or (b) a type of mobile structure that the mobile device was located within when the first instance of radio observation data was captured.

In an example embodiment, the reference signal strength is accessed from a radio map based on the first location and an identifier of the at least one first radio node.

In an example embodiment, the reference signal strength is determined at least in part based on the first instance of radio observation data and a second instance of radio observation data of the plurality of instances of radio observation data, the second instance of radio observation data is associated with a second instance of location data indicating a second location located within a set distance of the first location, the second instance of radio observation data is associated with a second context that is different from the first context.

In an example embodiment, the signal strength correction is a difference between the first observed signal strength of the at least one first radio node as indicated by the first instance of radio observation data and a second observed signal strength of the at least one first radio node as indicated by the second instance of radio observation data.

In an example embodiment, the method further comprises determining a respective context for each instance of radio observation data of the plurality instances of radio observation data based on at least one of a respective circumstance parameter or a respective location indicated by a respective instance of location data.

In an example embodiment, the respective context corresponds to a respective type of mobile structure that the mobile device was located within when the respective instance of radio data was captured, the respective type of mobile structure being one of no mobile structure, train, train type, train model, a particular train car, tram, car, bus, airplane, boat, market booth, temporary outdoor venue (e.g., concert venue, convention venue, and/or the like), fair structure, or other mobile (e.g., movable and/or temporary) structure.

In an example embodiment, the plurality of instances of radio observation data comprises a first group of consecutive instances of radio observation data that are associated with the first context and a second group of consecutive instances of radio observation data that are associated with a second context, the first signal strength correction is used to generate corrected signal strengths corresponding to the instances of radio observation data of the first group, and a second signal strength correction is determined and used to generate corrected signal strengths corresponding to the instances of radio observation data of the second group.

In an example embodiment, the first instance of radio observation data indicates respective first observed signal strengths for a first radio node and a second radio node, and at least one of (a) when respective reference signal strengths at the first location are available for both the first radio node and the second radio node, the first signal strength correction is determined based on a combination of the respective first observed signal strengths and the respective reference signal strengths for both the first radio node and the second radio node, (b) when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node regardless of respective transmission frequencies or transmission channels of the first and second radio node, or (c) when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node only when the first and second radio node are associated with a same transmission frequency or transmission channel.

In an example embodiment, when a second instance of radio observation data indicates a second observed signal strength of a second radio node and the second instance of radio observation data is associated with the first context, the first signal strength correction and the second observed signal strength are used to generate a corrected signal strength at a second location for the second radio node, the second location indicated by a second instance of location data associated with the second instance of radio observation data.

In another aspect of the present disclosure an apparatus (e.g., a computing device such as a network device) is provided. In an example embodiment, the apparatus comprises at least one processor and at least one memory storing computer program code and/or instructions. The at least one memory and the computer program code and/or instructions are configured to, with the processor, cause the apparatus to at least obtain a plurality and/or time-ordered sequence of instances of radio data generated by a mobile device. The plurality and/or time-ordered sequence of instances of radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data. Each instance of radio observation data of the plurality of instances of radio observation data indicates a respective observed signal strength of a respective at least one radio node. Each respective instance of location data of the plurality of instances of location data indicates a respective location of the mobile device when the mobile device captured an associated instance of radio observation data. Each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data. The plurality and/or time-ordered sequence of instances of radio data comprises a first instance of radio observation data associated with a first instance of location data and a first circumstance parameter. The first instance of radio observation data indicates a first observed signal strength of at least one first radio node at a first location indicated by the first instance of location data while the mobile device was at least one of moving with a characteristic of motion and/or experiencing an environment indicated by the first circumstance parameter. The at least one memory and the computer program code and/or instructions are further configured to, with the processor, cause the apparatus to at least determine a first context indicating a context under which the first instance of radio observation data was captured based on at least one of the first circumstance parameter or the first location. The at least one memory and the computer program code and/or instructions are further configured to, with the processor, cause the apparatus to at least determine a reference signal strength of the at least one first radio node at the first location based at least on the first location. The at least one memory and the computer program code and/or instructions are further configured to, with the processor, cause the apparatus to at least determine a first signal strength correction corresponding to the first context based on the reference signal strength and the first observed signal strength of the at least one first radio node. The at least one memory and the computer program code and/or instructions are further configured to, with the processor, cause the apparatus to at least generate one or more corrected signal strengths by adjusting one or more observed signal strengths of the plurality instances of radio observation data respectively associated with the first context using the first signal strength correction. Each corrected signal strength of the one or more corrected signal strengths is associated with a respective instance of location data of the plurality of instances of location data.

In an example embodiment, the at least one memory and the computer program code and/or instructions are further configured to, with the processor, cause the apparatus to at least generate or update a radio map based on the one or more corrected signal strengths and the associated respective instances of location data; and store and/or provide the radio map for at least use in performing one or more positioning and/or navigation-related functions.

In an example embodiment, the radio map is specific to the first context.

In an example embodiment, the context under which the first instance of radio observation data was captured indicates at least one of (a) a mobility state of the mobile device when the first instance of radio observation data was captured or (b) a type of mobile structure that the mobile device was located within when the first instance of radio observation data was captured.

In an example embodiment, the reference signal strength is accessed from a radio map based on the first location and an identifier of the at least one first radio node.

In an example embodiment, the reference signal strength is determined at least in part based on the first instance of radio observation data and a second instance of radio observation data of the plurality of instances of radio observation data, the second instance of radio observation data is associated with a second instance of location data indicating a second location located within a set distance of the first location, the second instance of radio observation data is associated with a second context that is different from the first context.

In an example embodiment, the signal strength correction is a difference between the first observed signal strength of the at least one first radio node as indicated by the first instance of radio observation data and a second observed signal strength of the at least one first radio node as indicated by the second instance of radio observation data.

In an example embodiment, the at least one memory and the computer program code and/or instructions are further configured to, with the processor, cause the apparatus to at least determine a respective context for each instance of radio observation data of the plurality instances of radio observation data based on at least one of a respective circumstance parameter or a respective location indicated by a respective instance of location data.

In an example embodiment, the respective context corresponds to a respective type of mobile structure that the mobile device was located within when the respective instance of radio data was captured, the respective type of mobile structure being one of no mobile structure, train, train type, train model, a particular train car, tram, car, bus, airplane, boat, market booth, temporary outdoor venue (e.g., concert venue, convention venue, and/or the like), fair structure, or other mobile (e.g., movable and/or temporary) structure.

In an example embodiment, the plurality of instances of radio observation data comprises a first group of consecutive instances of radio observation data that are associated with the first context and a second group of consecutive instances of radio observation data that are associated with a second context, the first signal strength correction is used to generate corrected signal strengths corresponding to the instances of radio observation data of the first group, and a second signal strength correction is determined and used to generate corrected signal strengths corresponding to the instances of radio observation data of the second group.

In an example embodiment, the first instance of radio observation data indicates respective first observed signal strengths for a first radio node and a second radio node, and at least one of (a) when respective reference signal strengths at the first location are available for both the first radio node and the second radio node, the first signal strength correction is determined based on a combination of the respective first observed signal strengths and the respective reference signal strengths for both the first radio node and the second radio node, (b) when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node regardless of respective transmission frequencies or transmission channels of the first and second radio node, or (c) when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node only when the first and second radio node are associated with a same transmission frequency or transmission channel.

In an example embodiment, when a second instance of radio observation data indicates a second observed signal strength of a second radio node and the second instance of radio observation data is associated with the first context, the first signal strength correction and the second observed signal strength are used to generate a corrected signal strength at a second location for the second radio node, the second location indicated by a second instance of location data associated with the second instance of radio observation data.

In still another aspect of the present disclosure, a computer program product is provided. In an example embodiment, the computer program product comprises at least one non-transitory computer-readable storage medium having computer-readable program code and/or instructions portions stored therein. The computer-readable program code and/or instructions portions comprise executable portions configured, when executed by a processor of an apparatus, to cause the apparatus to obtain a plurality and/or time-ordered sequence of instances of radio data generated by a mobile device. The plurality and/or time-ordered sequence of instances of radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data. Each instance of radio observation data of the plurality of instances of radio observation data indicates a respective observed signal strength of a respective at least one radio node. Each respective instance of location data of the plurality of instances of location data indicates a respective location of the mobile device when the mobile device captured an associated instance of radio observation data. Each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data. The plurality and/or time-ordered sequence of instances of radio data comprises a first instance of radio observation data associated with a first instance of location data and a first circumstance parameter. The first instance of radio observation data indicates a first observed signal strength of at least one first radio node at a first location indicated by the first instance of location data while the mobile device was at least one of moving with a characteristic of motion and/or experiencing an environment indicated by the first circumstance parameter. The computer-readable program code and/or instructions portions comprise executable portions further configured, when executed by a processor of an apparatus, to cause the apparatus to determine a first context indicating a context under which the first instance of radio observation data was captured based on at least one of the first circumstance parameter or the first location. The computer-readable program code and/or instructions portions comprise executable portions further configured, when executed by a processor of an apparatus, to cause the apparatus to determine a reference signal strength of the at least one first radio node at the first location based at least on the first location. The computer-readable program code and/or instructions portions comprise executable portions further configured, when executed by a processor of an apparatus, to cause the apparatus to determine a first signal strength correction corresponding to the first context based on the reference signal strength and the first observed signal strength of the at least one first radio node. The computer-readable program code and/or instructions portions comprise executable portions further configured, when executed by a processor of an apparatus, to cause the apparatus to generate one or more corrected signal strengths by adjusting one or more observed signal strengths of the plurality instances of radio observation data respectively associated with the first context using the first signal strength correction. Each corrected signal strength of the one or more corrected signal strengths is associated with a respective instance of location data of the plurality of instances of location data.

In an example embodiment, the computer-readable program code and/or instructions portions comprise executable portions further configured, when executed by a processor of an apparatus, to cause the apparatus to generate or update a radio map based on the one or more corrected signal strengths and the associated respective instances of location data; and store and/or provide the radio map for at least use in performing one or more positioning and/or navigation-related functions.

In an example embodiment, the radio map is specific to the first context.

In an example embodiment, the context under which the first instance of radio observation data was captured indicates at least one of (a) a mobility state of the mobile device when the first instance of radio observation data was captured or (b) a type of mobile structure that the mobile device was located within when the first instance of radio observation data was captured.

In an example embodiment, the reference signal strength is accessed from a radio map based on the first location and an identifier of the at least one first radio node.

In an example embodiment, the reference signal strength is determined at least in part based on the first instance of radio observation data and a second instance of radio observation data of the plurality of instances of radio observation data, the second instance of radio observation data is associated with a second instance of location data indicating a second location located within a set distance of the first location, the second instance of radio observation data is associated with a second context that is different from the first context.

In an example embodiment, the signal strength correction is a difference between the first observed signal strength of the at least one first radio node as indicated by the first instance of radio observation data and a second observed signal strength of the at least one first radio node as indicated by the second instance of radio observation data.

In an example embodiment, the computer-readable program code and/or instructions portions comprise executable portions further configured, when executed by a processor of an apparatus, to cause the apparatus to determine a respective context for each instance of radio observation data of the plurality instances of radio observation data based on at least one of a respective circumstance parameter or a respective location indicated by a respective instance of location data.

In an example embodiment, the respective context corresponds to a respective type of mobile structure that the mobile device was located within when the respective instance of radio data was captured, the respective type of mobile structure being one of no mobile structure, train, train type, train model, a particular train car, tram, car, bus, airplane, boat, market booth, temporary outdoor venue (e.g., concert venue, convention venue, and/or the like), fair structure, or other mobile (e.g., movable and/or temporary) structure.

In an example embodiment, the plurality of instances of radio observation data comprises a first group of consecutive instances of radio observation data that are associated with the first context and a second group of consecutive instances of radio observation data that are associated with a second context, the first signal strength correction is used to generate corrected signal strengths corresponding to the instances of radio observation data of the first group, and a second signal strength correction is determined and used to generate corrected signal strengths corresponding to the instances of radio observation data of the second group.

In an example embodiment, the first instance of radio observation data indicates respective first observed signal strengths for a first radio node and a second radio node, and at least one of (a) when respective reference signal strengths at the first location are available for both the first radio node and the second radio node, the first signal strength correction is determined based on a combination of the respective first observed signal strengths and the respective reference signal strengths for both the first radio node and the second radio node, (b) when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node regardless of respective transmission frequencies or transmission channels of the first and second radio node, or (c) when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node only when the first and second radio node are associated with a same transmission frequency or transmission channel.

In an example embodiment, when a second instance of radio observation data indicates a second observed signal strength of a second radio node and the second instance of radio observation data is associated with the first context, the first signal strength correction and the second observed signal strength are used to generate a corrected signal strength at a second location for the second radio node, the second location indicated by a second instance of location data associated with the second instance of radio observation data.

According to yet another aspect, an apparatus is provided. In an example embodiment, the apparatus comprises means for obtaining a plurality and/or time-ordered sequence of instances of radio data generated by a mobile device. The plurality and/or time-ordered sequence of instances of radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data. Each instance of radio observation data of the plurality of instances of radio observation data indicates a respective observed signal strength of a respective at least one radio node. Each respective instance of location data of the plurality of instances of location data indicates a respective location of the mobile device when the mobile device captured an associated instance of radio observation data. Each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data. The plurality and/or time-ordered sequence of instances of radio data comprises a first instance of radio observation data associated with a first instance of location data and a first circumstance parameter. The first instance of radio observation data indicates a first observed signal strength of at least one first radio node at a first location indicated by the first instance of location data while the mobile device was at least one of moving with a characteristic of motion and/or experiencing an environment indicated by the first circumstance parameter. The apparatus comprises means for determining a first context indicating a context under which the first instance of radio observation data was captured based on at least one of the first circumstance parameter or the first location. The apparatus comprises means for determining a reference signal strength of the at least one first radio node at the first location based at least on the first location. The apparatus comprises means for determining a first signal strength correction corresponding to the first context based on the reference signal strength and the first observed signal strength of the at least one first radio node. The apparatus comprises means for generating one or more corrected signal strengths by adjusting one or more observed signal strengths of the plurality instances of radio observation data respectively associated with the first context using the first signal strength correction. Each corrected signal strength of the one or more corrected signal strengths is associated with a respective instance of location data of the plurality of instances of location data.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 illustrates an example system of one embodiment of the present disclosure;

FIG. 2A is a block diagram of a network device that may be specifically configured in accordance with an example embodiment;

FIG. 2B is a block diagram of a mobile device that may be specifically configured in accordance with an example embodiment;

FIG. 2C is a block diagram of a computing entity that may be specifically configured in accordance with an example embodiment;

FIG. 3 is a conceptual diagram illustrating various components, in accordance with an example embodiment;

FIG. 4 is a flowchart illustrating operations performed, such as by the mobile device of FIG. 2B, in accordance with an example embodiment;

FIG. 5 is a flowchart illustrating operations performed, such as by the network device of FIG. 2A, for generating and/or using corrected signal strengths, in accordance with an example embodiment;

FIG. 6 is a flowchart illustrating operations performed, such as by the network device of FIG. 2A, for determining a signal strength correction, in accordance with an example embodiment;

FIG. 7 is a flowchart illustrating operations performed, such as by the network device of FIG. 2A, for determining a signal strength correction, in accordance with an example embodiment; and

FIG. 8 is a flowchart illustrating operations performed, such as by the network device of FIG. 2A or the computing entity of FIG. 2C, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or tolerances. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Various embodiments provide methods, apparatus, systems, and computer program products for correcting observed radio signal characteristics for effects caused by observing the radio signals from within a mobile structure. Various embodiments provide methods, apparatus, systems, and computer program products for generating radio maps based on radio observation data that has been corrected for the effects caused by observing radio signals from within a mobile structure. Various embodiments provide methods, apparatus, systems, and computer program products for utilizing radio observation data that has been corrected for the effects caused by observing radio signals from within a mobile structure when using a radio map to perform positioning and/or navigation-related functions.

In various scenarios, when a mobile device or computing entity observes radio signal from within a mobile structure, the mobile structure may cause the observed signal to be attenuated (with respect to a nearby position located just outside the mobile structure or with respect to the same position when the mobile structure is not present). In various scenarios, the mobile structure may include a signal repeater or other amplifier that causes the observed radio signal within the mobile structure to be amplified (with respect to a nearby position located just outside the mobile structure or with respect to the same position when the mobile structure is not present). Thus, when a mobile device or computing entity observes the radio signal at a position within the mobile structure, there may be an offset between observed characteristics of the radio signal (e.g., the observed signal strength) and the signal strength of the radio signal at the same position when the mobile structure is not present at the position.

In various embodiments, a sequence of instances of radio data are obtained, processed, and/or analyzed. The instances of radio data of the sequence of instances of radio data include associated respective instances of radio observation data, instances of location data, and circumstance parameters. In various embodiments, the instance of radio observation data, instance of location data, and circumstance parameter of an instance of radio data are generated based on sensor data and/or observations captured by sensors that are part of, physically coupled to, and/or physically associated with the mobile device.

In various embodiments, an instance of radio observation data characterizes the observation of one or more radio signals by the mobile device that captured the instance of radio data. For example, an instance of radio observation data includes information identifying a radio node (e.g., a radio node identifier such as a media access control (MAC) address, a global system/standard for mobile communication(s) (GSM) cell identifier, and/or the like), a radio type of the radio node (e.g., cellular, Wi-Fi, Bluetooth, and/or the like), a signal frequency and/or frequency-band, an observed signal characteristic (e.g., an observed signal strength), and/or the like.

In various embodiments, an instance of location data indicates a position estimate of the mobile device when the mobile device captured the corresponding instance of radio observation data (e.g., observed the radio signals characterized by the instance of radio observation data). In various embodiments, the position estimate may be determined using a global navigation satellite system (GNSS) sensor, radio-based positioning, inertial measurement unit (IMU) and/or motion-based positioning, hybrid positioning (e.g., using a combination of GNSS-based, radio-based, IMU and/or motion-based, and/or other positioning techniques). In various embodiments, the position estimate is provided as a latitude-longitude pair, possibly with the addition of a height/elevation/altitude. For example, the position estimate may be with reference to a global and/or earth-centered reference frame. In an example embodiment, the position estimate is provided with respect to a local reference point or frame.

In various embodiments, a circumstance parameter characterizes the motion state and/or at least a portion of the environment about the mobile device when the mobile device captured the corresponding instance of radio observation data. A context under which an instance of radio data is determined based on the respective instance of location data and/or circumstance parameter. In various embodiments, the context under which an instance of radio observation data was captured indicates at least one of (a) a mobility state of the mobile device when the instance of radio observation data was captured or (b) a type of mobile structure that the mobile device was located within when the instance of radio observation data was captured. For example, the circumstance parameter may comprise and/or be determined based on sensor data captured by motion sensors, audio sensors, and/or other sensors physically associated with the mobile device.

In various embodiments, the sequence of instances of radio data includes instances of radio data captured under one or more contexts. A signal characteristic correction (e.g., a signal strength correction) corresponding to a particular context is determined and corrected signal characteristics corresponding to one or more instances of radio observation data of the sequence of instances of radio data captured under the particular context may be generated based on the determined signal characteristic correction. Different signal characteristic corrections may be determined for other contexts under which other instances of radio data of the sequence of instances of radio data were captured such that the other instances of radio data may also be corrected.

In various embodiments, a radio map is generated and/or updated based on the corrected signal characteristics. In various embodiments, the radio map is used to perform positioning and/or navigation-related functions. In various embodiments, context-specific corrections may be tracked and/or determined for use when using the radio map to perform positioning and/or navigation-related functions.

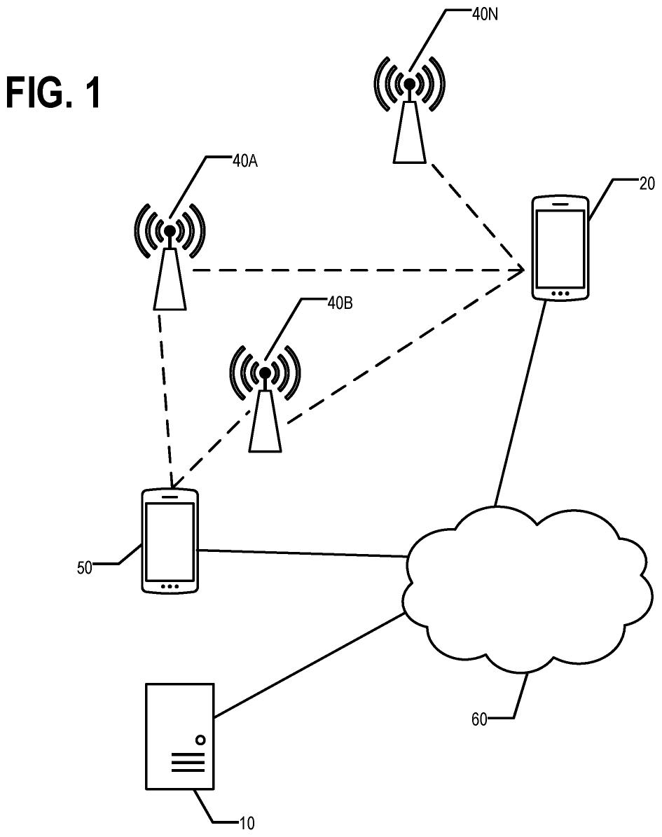

FIG. 1 provides an illustration of an example system that can be used in conjunction with various embodiments of the present invention. As shown in FIG. 1, the system includes one or more network devices 10, one or more mobile devices 20, one or more computing entities 50, one or more networks 60, and/or the like. In various embodiments, the system further includes one or more radio nodes 40 (e.g., 40A, 40B, 40N). In various embodiments, a mobile device 20 and/or a computing entity 50 is a smart phone, tablet, laptop, personal digital assistant (PDA), mobile computing device, and/or the like. In an example embodiment, the network device 10 is a server, group of servers, distributed computing system, part of a cloud-based computing system, and/or other computing system. In various embodiments, the radio nodes 40 are wireless network access points and/or gateways such as Wi-Fi network access points, cellular network access points, Bluetooth access points, and/or the like; radio beacons; radio frequency identifier (RFID) tags; and/or other radio nodes that emit and/or broadcast radio frequency signals that may be used to enable positioning. For example, the network device 10 may be in communication with one or more mobile devices 20 and/or computing entities 50, via one or more wired or wireless networks 60.

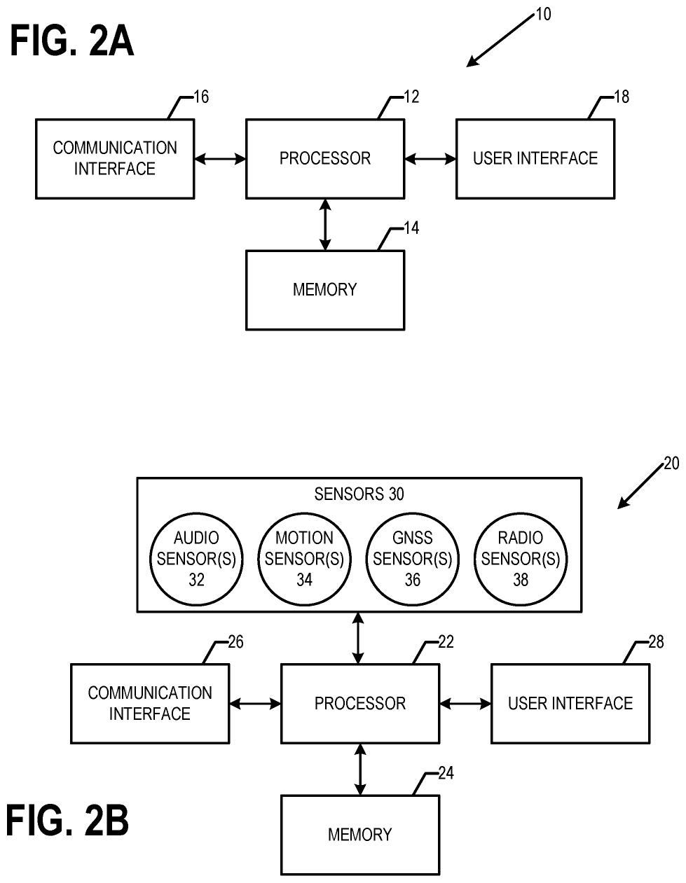

In an example embodiment, a network device 10 comprises components similar to those shown in the example network device 10 diagrammed in FIG. 2A. In an example embodiment, the network device 10 is configured to obtain a pluralities or a sequences of instances of radio data, the pluralities or sequences respectively generated by one or more mobile devices 20. An instance of radio comprises an instance of radio observation data, an instance of location data, and a circumstance parameter that were captured at substantially the same time and/or reflect sensor data and/or observations captured by sensors that are physically associated with a mobile device 20. The network device 10 is configured to determine a reference signal characteristic (e.g., reference signal strength) for at least one radio node at a location proximate at least one position estimate of the instances of location data of the instances of radio data; determine a context under which at least one instance of radio data was captured; determine a signal characteristic correction (e.g., a signal strength correction) corresponding to the context; and determining a corrected signal characteristic (e.g., corrected signal strength) for at least one instance of radio data associated with the context based on the determined signal characteristic correction. In various embodiments, the network device 10 generates and/or updates a radio map based on the corrected signal characteristic, stores and/or provides the map for use in performing positioning and/or navigation-related functions, stores information regarding the signal characteristic correction corresponding to the context, and/or the like. For example, the network device 10 may provide at least a portion of the radio map and/or information regarding the signal characteristic correction for the context to a crowd-sourcing and/or positioning process operating on the network device 10 or a computing entity 50, and/or the like.

For example, as shown in FIG. 2A, the network device 10 may comprise a processor 12, memory 14, a user interface 18, a communications interface 16, and/or other components configured to perform various operations, procedures, functions, or the like described herein. In various embodiments, the network device 10 stores a geographical database and/or positioning map, such as a radio map (e.g., describing the radio environment and/or radio node locations in a geographic region), computer program code and/or instructions for one or more crowd-sourcing or positioning functions, computer program code and/or instructions for determining a context based on an instance of location data and circumstance parameter(s), determining a signal characteristic correction corresponding to a context, and/or the like (e.g., in memory 14), for example. In at least some example embodiments, the memory 14 is non-transitory.

In an example embodiment, the mobile device 20 is configured to capture instances of radio observation data, instances of location data, and circumstance parameters; associate substantially simultaneously captured respective instances of radio observation data, instances of location data, and circumstance parameters to form instances of radio data; provide the instances of radio data; and/or the like.

In an example embodiment, the mobile device 20 is a mobile computing device such as a smartphone, tablet, laptop, PDA, an Internet of things (IoT) device, and/or the like. In an example embodiment, as shown in FIG. 2B, the mobile device 20 may comprise a processor 22, memory 24, a communications interface 26, a user interface 28, one or more sensors 30 and/or other components configured to perform various operations, procedures, functions or the like described herein. In various embodiments, the mobile device 20 stores at least a portion of one or more digital maps (e.g., geographic databases, radio maps, positioning maps, and/or the like) and/or computer executable instructions for generating and providing instances of radio data and/or the like in memory 24. In at least some example embodiments, the memory 24 is non-transitory.

In various embodiments, the sensors 30 comprise one or more audio sensors 32, one or more motion sensors 34, one or more GNSS sensors 36, one or more radio sensors 38, and/or other sensors. In an example embodiment, the one or more audio sensors 32 comprise one or more microphones and/or other audio sensors. In an example embodiment, the one or more motion sensors 34 comprise one or more IMU sensors, accelerometers, gyroscopes, magnetometers, barometers, and/or the like. In various embodiments, the one or more GNSS sensor(s) 36 are configured to communicate with one or more GNSS satellites and determine GNSS-based location estimates and/or other information based on the communication with the GNSS satellites. In various embodiments, the one or more radio sensors 38 comprise one or more radio interfaces configured to observe and/or receive signals generated and/or transmitted by one or more radio nodes, access points, and/or other computing entities (e.g., radio nodes 40). For example, the one or more interfaces may be configured (possibly in coordination with processor 22) to determine a locally unique identifier, globally unique identifier, and/or operational parameters of a radio node 40 observed by the radio sensor(s) 38. As used herein, a radio sensor 38 observes a radio node 40 by receiving, capturing, measuring and/or observing a signal emitted, broadcasted, generated, and/or transmitted by the radio node 40. In an example embodiment, the interface of a radio sensor 38 may be configured to observe one or more types of signals such as generated and/or transmitted in accordance with one or more protocols such as 5G new radio (NR), general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), LTE Advanced (LTE-A), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor 38 may be configured to observe signals of one or more modern global cellular formats such as GSM, WCDMA, TD-SCDMA, LTE, LTE-A, CDMA, narrow band (NB)-IoT and/or non-cellular formats such as wireless local area network (WLAN), Bluetooth, Bluetooth Low Energy (BLE), Zigbee, LoRa, and/or the like. For example, the interface(s) of the radio senor(s) 38 may be configured to observe radio, millimeter, microwave, and/or infrared wavelength signals. In an example embodiment, the interface of radio sensor 38 may be coupled to and/or part of a communications interface 26. In various embodiments, the sensors 30 may further comprise one or more image sensors configured to capture visual samples, such as digital camera(s), three-dimensional (3D) cameras, 360° cameras, and/or image sensors. In various embodiments, the one or more sensors 30 may comprise various other sensors such as two dimensional (2D) and/or 3D light detection and ranging (LiDAR)(s), long, medium, and/or short range radio detection and ranging (RADAR), ultrasonic sensors, electromagnetic sensors, (near-) infrared (IR) cameras.

In an example embodiment, the computing entity 50 is configured to capture an instance of radio observation data and one or more corresponding circumstance parameters (e.g., at substantially the same time as the capturing of the instance of radio observation data); perform one or more positioning and/or navigation-related functions based on the instance of radio observation data, a context determined at least in part based on the one or more corresponding circumstance parameters, and the radio map; and/or the like.

In an example embodiment, the computing entity 50 is a mobile computing device such as a smartphone, tablet, laptop, PDA, an IoT device, and/or the like. In an example embodiment, as shown in FIG. 2C, the computing entity 50 may comprise a processor 52, memory 54, a communications interface 56, a user interface 58, one or more sensors 59 and/or other components configured to perform various operations, procedures, functions or the like described herein. In various embodiments, the computing entity 50 stores at least a portion of one or more digital maps (e.g., geographic databases, radio maps, positioning maps, and/or the like) and/or computer executable instructions for generating and providing instances of radio observation data and corresponding circumstance parameters and/or the like in memory 54. In at least some example embodiments, the memory 54 is non-transitory.

In various embodiments, the sensors 59 comprise one or more audio sensors, one or more motion sensors, one or more GNSS sensors, one or more radio sensors, and/or other sensors. In an example embodiment, the one or more audio sensors comprise one or more microphones and/or other audio sensors. In an example embodiment, the one or more motion sensors comprise one or more IMU sensors, accelerometers, gyroscopes, magnetometers, barometers, and/or the like. In various embodiments, the one or more GNSS sensor(s) are configured to communicate with one or more GNSS satellites and determine GNSS-based location estimates and/or other information based on the communication with the GNSS satellites. In various embodiments, the one or more radio sensors comprise one or more radio interfaces configured to observe and/or receive signals generated and/or transmitted by one or more radio nodes, access points, and/or other computing entities (e.g., radio nodes 40). For example, the one or more interfaces may be configured (possibly in coordination with processor 52) to determine a locally unique identifier, globally unique identifier, and/or operational parameters of a radio node 40 observed by the radio sensor(s). As used herein, a radio sensor observes a radio node 40 by receiving, capturing, measuring and/or observing a signal emitted, broadcasted, generated, and/or transmitted by the radio node 40. In an example embodiment, the interface of a radio sensor may be configured to observe one or more types of signals such as generated and/or transmitted in accordance with one or more protocols such as 5G NR, GPRS, UMTS, CDMA2000, 1×RTT, WCDMA, GSM, EDGE, TD-SCDMA, LTE, LTE-A, E-UTRAN, EVDO, HSPA, HSDPA, Wi-Fi, Wi-Fi Direct, WiMAX, UWB, IR protocols, NFC protocols, Wibree, Bluetooth protocols, wireless USB protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, BLE, Zigbee, LoRa, and/or the like. For example, the interface(s) of the radio senor(s) may be configured to observe radio, millimeter, microwave, and/or infrared wavelength signals. In an example embodiment, the interface of radio sensor may be coupled to and/or part of a communications interface 56. In various embodiments, the sensors 59 may further comprise one or more image sensors configured to capture visual samples, such as digital camera(s), 3D cameras, 360° cameras, and/or image sensors. In various embodiments, the one or more sensors 30 may comprise various other sensors such as 2D and/or 3D LiDAR(s), long, medium, and/or short range RADAR, ultrasonic sensors, electromagnetic sensors, (near-) IR cameras.

Each of the components of the system may be in electronic communication with, for example, one another over the same or different wireless or wired networks 60 including, for example, a wired or wireless Personal Area Network (PAN), Local Area Network (LAN), Metropolitan Area Network (MAN), Wide Area Network (WAN), cellular network, and/or the like. In an example embodiment, a network 60 comprises the automotive cloud, digital transportation infrastructure (DTI), radio data system (RDS)/high definition (HD) radio or other digital radio system, and/or the like. For example, a mobile device 20 and/or computing entity 50 may be in communication with a network device 10 via the network 60. For example, a mobile device 20 and/or computing entity 50 may communicate with the network device 10 via a network, such as the Cloud. For example, the Cloud may be a computer network that provides shared computer processing resources and data to computers and other devices connected thereto. For example, the mobile device 20 captures instances of radio data and provides the instances of radio data such that the network device 10 receives the instance of radio data via the network 60. For example, the network device 10 may be configured to provide at least a portion of a radio map and/or receive instances of radio data via the network 60.

Certain example embodiments of the network device 10, mobile device 20, and/or computing entity 50 are described in more detail below with respect to FIGS. 2A, 2B, and 2C.

### II. Example Operation(s)

In various embodiments, mobile devices 20 generate and provide pluralities and/or (time-ordered) sequences of instances of radio data. An instance of radio data comprises an instance of radio observation data, an instance of location data, and one or more circumstance parameters that were captured substantially simultaneously. Each instance of radio observation data includes information identifying a radio node (e.g., a radio node identifier such as a media access control (MAC) address, a global system/standard for mobile communication(s) (GSM) cell identifier, and/or the like), a radio type of the radio node (e.g., cellular, Wi-Fi, Bluetooth, and/or the like), a signal frequency and/or frequency-band, an observed signal characteristic (e.g., an observed signal strength), and/or the like. Each instance of location data indicates a respective location or position estimate of the mobile device 20 when the mobile device 20 captured the associated instance of radio observation data. Each circumstance parameter is generated based on sensor data captured by sensors 30 of the mobile device 20 and indicates a characteristic of motion of the mobile device 20 when the mobile device 20 captured the associated instance of radio observation data. For example, the circumstance parameter may be and/or include audio data, acceleration data, velocity data, heading data, barometer data, and/or the like. The mobile device 20 provides a plurality and/or sequence of instances of radio data such that the network device 10 receives the plurality and/or sequence of instances of radio data.

In various embodiments a network device 10 obtains a plurality and/or (time-ordered) sequence of instances of radio data. For example, the network device 10 may obtain the plurality and/or (time-ordered) sequence of instance of radio data by receiving the plurality and/or sequence via communication interface 16, accessing the plurality and/or sequence from memory 14, and/or the like. In various embodiments, a plurality and/or (time-ordered) sequence of instances of radio data include an instance of radio data comprising a first instance of radio observation data comprising a first observed signal characteristic (e.g., a first observed signal strength) for a first radio node, a first instance of location data indicating a first location, and a first circumstance parameter.

Based on the first location and the first circumstance parameter, the network device 10 determines a first context corresponding to the context under which the first instance of radio observation data was captured by the mobile device 20. In various embodiments, the context under which an instance of radio observation data was captured indicates at least one of (a) a mobility state of the mobile device when the instance of radio observation data was captured or (b) a type of mobile structure that the mobile device was located within when the instance of radio observation data was captured. The network device 10 also determines a reference signal characteristic (e.g., reference signal strength) for the first radio node at a location proximate (e.g., within a set distance) the first location. Based on the difference between the first observed signal characteristic and the reference signal characteristic, a first signal characteristic correction (e.g., a first signal strength correction) corresponding to the first context is determined. Other instances of radio data that are associated with the first context (e.g., as determined based on the respective locations indicated by the respective instances of location data and/or the circumstance parameters) are identified and the first signal characteristic correction is used to generate corrected signal characteristics (e.g., corrected signal strengths) for the instances of radio data associated with the first context. For instances of radio data that are associated with a second context (that is different from the first context), a second signal characteristic correction may be determined and applied to generate respective corrected signal characteristics.

The network device 10 uses the corrected signal characteristics (e.g., corrected signal strengths), in association with the respective instances of location data, to generate and/or update a radio map. The radio map may then be used by the network device 10, computing entity 50, and/or the like (e.g., a Cloud-based service) to perform positioning and/or navigation-related functions. In an example embodiment, the network device 10 stores context-specific distributions of signal characteristic corrections. These context-specific distributions may be used to determine signal characteristic corrections used when performing positioning and/or navigation-related functions using the radio map, determining a context corresponding to an instance of radio observation data, and/or the like.

In various embodiments, a computing entity 50 is configured to generate an instance of radio observation data and a corresponding one or more circumstance parameters. Based on the instance of radio observation data and, possibly, the corresponding one or more circumstance parameters, the computing entity 50 may use at least a portion of the radio map to perform a positioning and/or navigation-related function. In an example embodiment, the computing entity 50 provides the instance of radio observation data and the corresponding one or more circumstance parameters (e.g., such that they are received by a network device 10, Cloud-based service, and/or the like) and receives the results of a positioning and/or navigation-related function performed based on instance of radio observation data, the corresponding one or more circumstance parameters, and at least a portion of the radio map.

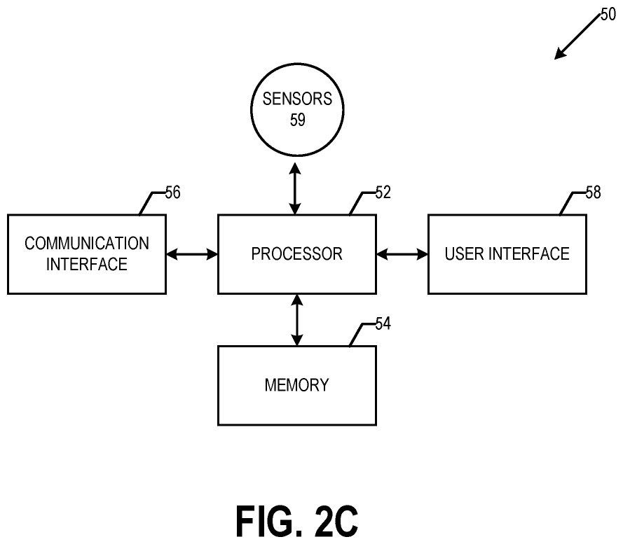

FIG. 3 is a conceptual diagram illustrating a plurality of locations 310 (e.g., 310A-J) at which a mobile device 20 generated respective instances of radio data. Locations 310A and 310H are located on first and second train platforms 355A, 355B, respectively; locations 310B-G are located generally along railroad tracks 350; and locations 310I-J are located generally along road 340. Based on the respective locations and respective circumstance parameters, the network device 10 may determine that the instances of radio data corresponding to locations 310B-310G were generated under a first context (e.g., onboard a train), the instances of radio data corresponding to locations 310I-310J were generated under a second context (e.g., within a passenger vehicle), and the instances of radio data corresponding to locations 310A and 310H were generated under a third context (e.g., no mobile structure).

In an example embodiment, a first signal characteristic correction (e.g., signal strength correction) for the first context is determined based at least in part on the observed signal characteristic (e.g., observed signal strength) at location 310B and a reference signal characteristic (e.g., reference signal strength). In an example embodiment, the reference signal characteristic is the observed signal characteristic at location 310A (e.g., as indicated by an instance of radio observation data that is associated with an instance of location data indicating location 310A) when the distance d1 between locations 310A and 310B is less than or equal to a set distance D (e.g., when d1≤D) and the context corresponding to he observed signal characteristic at location 310A is no mobile structure and/or the like. In an example embodiment, the reference signal characteristic is a signal characteristic value (e.g., signal strength value) accessed from a radio map, for example, and that corresponds to a location that is within the set distance D of location 310B. The first signal characteristic correction may then be used to generated corrected signal strength characteristics for each of the instances of radio observation data associated with instances of location data corresponding to locations 310B-310G. For example, the first signal characteristic correction, corresponding to the first context, may be used to generate and/or determine respective corrected signal characteristics corresponding to the instances of radio data associated with the first context. However, the first signal characteristic correction is not used, in an example embodiment, to generate or determine respective corrected signal characteristics for instances of radio data associated with the second or third contexts (e.g., corresponding to locations 310A, 310H and 310I-J).

### A. Operation of a Mobile Device to Generate and Provide a Plurality or Sequence of Instances of Radio Data

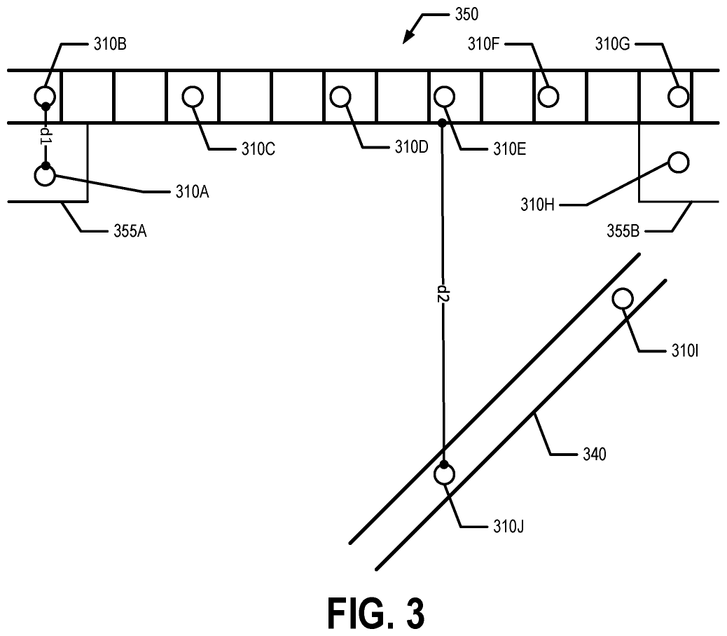

In various embodiments, a mobile device 20 generates and provides a plurality or (time-ordered) sequence of instances of radio data. FIG. 4 provides a flowchart illustrating various processes, procedures, operations, and/or the like performed by a mobile device 20 for generating and providing a plurality or a (time-ordered) sequence of instances of radio data, according to an example embodiment.

Starting at block 402, the mobile device 20 captures an instance of radio observation data. For example, the mobile device 20 comprises means, such as processor 22, memory 24, radio sensors 38, and/or the like, for capturing an instance of radio observation data. For example, the one or more radio sensors 38 may detect and/or receive one or more radio signals such that the one or more radio nodes 40 that emitted, broadcasted, generated, and/or transmitted the detected and/or received radio signals are observed by the mobile device 20. The radio sensors 38, possibly via the processor 24, may extract information from and/or determine characteristics of the detected and/or received radio signals and generate an instance of radio observation data including at least a portion of the information extracted from and/or characteristics determined of the detected and/or received radio signals. For example, the instance of radio observation data includes information identifying a radio node (e.g., a radio node identifier such as a media access control (MAC) address, a global system/standard for mobile communication(s) (GSM) cell identifier, and/or the like), a radio type of the radio node (e.g., cellular, Wi-Fi, Bluetooth, and/or the like), a signal frequency and/or frequency-band, an observed signal characteristic (e.g., an observed signal strength), and/or the like.

At block 404, the mobile device 20 captures an instance of location data. For example, the mobile device 20 comprises means, such as processor 22, memory 24, sensors 30 (e.g., audio sensors 32, motion sensors 34, GNSS sensors 36, radio sensors 38), and/or the like, for generating, determining, and/or capturing an instance of location data. In various embodiments, the instance of location data includes an indication of a location of the mobile device 20 at the moment when the instance of location data was generated, determined, and/or captured. In various embodiments, the indication of the location is provided as a position estimate determined using a global navigation satellite system (GNSS) sensor, radio-based positioning, inertial measurement unit (IMU) and/or motion-based positioning, hybrid positioning (e.g., using a combination of GNSS-based, radio-based, IMU and/or motion-based, and/or other positioning techniques), and/or other positioning technique. In various embodiments, the position estimate is provided as a latitude-longitude pair, possibly with the addition of a height/elevation/altitude. For example, the position estimate may be with reference to a global and/or earth-centered reference frame. In an example embodiment, the position estimate is provided with respect to a local reference point or frame. In various embodiments, the instance of location data is generated, determined, and/or captured at substantially the same time as instance of radio observation data such that the instance of location data indicates the location of the mobile device 20 when the mobile device 20 observed the radio signals characterized by the instance of radio observation data.

At block 404, the mobile device 20 captures one or more circumstance parameters. For example, the mobile device 20 comprises means, such as processor 22, memory 24, sensors 30 (e.g., audio sensors 32, motion sensors 34, GNSS sensors 36, radio sensors 38), and/or the like, for generating, determining, and/or capturing one or more circumstance parameters. In various embodiments, the circumstance parameters are generated, determined, and/or captured based on sensor data captured, measured, generated, and/or the like by one or more of the sensors 30. In various embodiments, a circumstance parameter indicates one or more characteristics of motion of the mobile device 20 at the moment when the circumstance parameters were captured. In various embodiments, the one or more circumstance parameters may include audio data (e.g., an audio recording of at least a portion of the environment about the mobile device 20), movement information (e.g., heading, velocity, acceleration, rotational velocity, rotational acceleration, and/or the like), image and/or visual data (e.g., a digital image of at least a portion of the environment about the mobile device 20), point cloud data (e.g., generated by a radar, LiDAR, and/or the like and configured to represent at least a portion of the environment about the mobile device 20), and/or other information/data characterizing the movement and/or environment about the mobile device 20 as determined based on sensor data captured, measured, generated, and/or the like by one or more sensors 30 of the mobile device 20. In an example embodiment, the one or more circumstance parameters are generated, determined, and/or captured at substantially the same time as the instance of radio observation data such that the one or more circumstance parameters characterize the movement and/or environment around the mobile device 20 when the mobile device 20 observed the radio signals characterized by the instance of radio observation data.

At block 408, the mobile device 20 associates the instance of radio observation data, instance of location data, and one or more circumstance parameters that were generated, determined, and/or captured at approximately the same time to form an instance of radio data. For example, the mobile device 20 comprises means, such as processor 22, memory 24, and/or the like for associating an instance of radio observation data, an instance of location data, and one or more circumstance parameters that were generated, determined, and/or captured at approximately the same time to form an instance of radio data. In an example embodiment, each of the instance of radio observation data, instance of location data, and one or more circumstance parameters include a time stamp indicating the date and/or time when the corresponding information was generated, determined, and/or captured. In such an embodiment, the instance of radio observation data, instance of location data, and the one or more circumstance parameters may be associated with and/or linked to one another via their respective time stamps. In an example embodiment, a respective instance of radio observation data, instance of location data, and one or more circumstance parameters are linked and/or associated to form an instance of radio data includes a single time stamp. For example, the instance of radio data may be a single data structure including an instance of radio observation data, an instance of location data, and one or more circumstance parameters, in an example embodiment. In another example embodiment, the instance of radio observation data, instance of location data, and the one more circumstance parameters are provided as two or more data structures that are linked to and/or associated with one another.

At block 410, the mobile device 20 provides one or more instances of radio data. For example, the mobile device 20 comprises means, such as processor 22, memory 24, communications interface 26, and/or the like, for providing one or more instances of radio data. For example, the mobile device 20 periodically and/or in a triggered manner generates, determines and/or captures instances of radio data. In an example embodiment, the mobile device 20 provides each instance of radio data as the instance is generated, determined, and/or captured. In an example embodiment, the mobile device 20 provides batches of instances of radio data at a time. For example, the mobile device 20 may provide a batch of instances of radio data every minute, every two minutes, every five minutes, every ten minutes, every twenty minutes, every half an hour, every hour, and/or the like. In an example embodiment, the mobile device 20 provides a batch of instances of radio data corresponding to the traversal of a route. In various embodiments, whether the instances of radio data are provided individually or in batches, the instances of radio data may be linked and/or associated with one another (e.g., based on a mobile device identifier, an anonymous identifier configured to allow the linking and/or identification of instances of radio data generated by a same mobile device 20, and/or the like) to provide a plurality and/or (time-ordered) sequence of instances of radio data for processing and/or analysis by the network device 10. In various embodiments, the mobile device 20 provides the one or more instances of radio data such that the network device 10 receives the one or more instances of radio data.

### B. Example Operation of a Network Device to Generate a Corrected Signal Characteristic

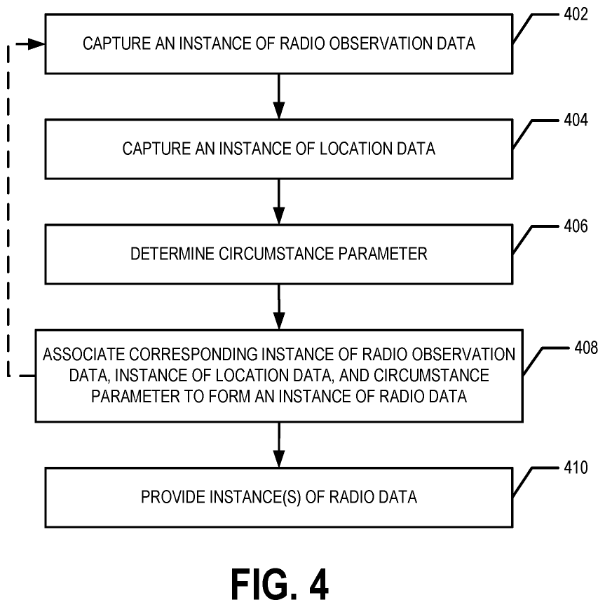

FIG. 5 provides a flowchart illustrating various processes, procedures, operations, and/or the like for generating corrected signal characteristics (e.g., corrected signal strengths) for respective instances of radio observation data and using the corrected signal characteristics. The processes, procedures, operations, and/or the like shown in FIG. 5 are described herein as being performed by the network device 10. However, in various embodiments, one or more of these processes, procedures, operations, and/or the like are performed by the mobile device 20, a computing entity 50, and/or the like.

Starting at block 502, the network device 10 obtains a plurality and/or (time-ordered) sequence of instances of radio data. For example, the network device 10 comprises means, such as processor 12, memory 14, communications interface 16, and/or the like, for obtaining a plurality and/or (time-ordered) sequence of instances of radio data. For example, the network device 10 may receive the plurality and/or (time-ordered) sequence of instances of radio data (e.g., individually and/or in one more batches). For example, the network device 10 may access the plurality and/or (time-ordered) sequence of instances of radio data from memory 14.

At block 504, the network device 10 determines respective contexts for respective instances of radio data. For example, the network device 10 comprises means, such as processor 12, memory 14, and/or the like, for determining respective contexts for respective instances of radio data. For example, the network device 10 determines a context corresponding to an instance of radio data based at least in part on the corresponding instance of location data and/or the corresponding one or more circumstance parameters. For example, in an example embodiment the one or circumstance parameters comprise audio data, such as an audio recording of at least a portion of the environment about the mobile device 20 when the components of the instance of radio data were generated, determined, and/or captured and the audio data may be analyzed by a context classification engine, such as the classification engine described by U.S. application Ser. No. 17/301,304, filed Mar. 31, 2021, the content of which is incorporated by reference herein in its entirety, to determine a corresponding context. In various embodiments, the context characterizes at least a portion of the environment about the mobile device and/or the situation under which the mobile device 20 captured the corresponding instance of radio data. For example, the context may indicate whether and/or what type of mobile structure the mobile device 20 was located in when the corresponding instance of radio data was captured. In an example embodiment, the context associated with an instance of radio data corresponds to a respective type of mobile structure the mobile device 20 was located in when the mobile device 20 captured the instance of radio data. The respective type of mobile structure is one of no mobile structure, train (e.g., commuter train, inter-city train, intra-city train, subterranean train, above ground train, and/or the like), train type, train model, a particular train car, tram, car, bus (e.g., public transportation bus, inter-city bus, intra-city bus), airplane, boat, market booth, temporary outdoor venue (e.g., concert venue, convention venue, and/or the like), fair structure, or other mobile (e.g., movable and/or temporary) structure, in an example embodiment.

In an example embodiment, the location indicated by the instance of location data may be map-matched to a digital map and used to determine one or more possible contexts and/or one or more not possible contexts for an instance of radio data. For example, referring to FIG. 3, location 310J is a distance d2 from the railroad tracks 350 and is located proximate road 340. Thus, based on the location 310J being a distance d2 from the railroad tracks 350, where the distance d2 is greater than a threshold distance, the network device 10 may determine that the instance of radio data corresponding to location 310J was not captured on a train. However, based on the location 310J being proximate road 340, the network device 10 may determine that the instance of radio data captured at location 310J may have been captured in a passenger car, public transportation bus, outside of a mobile structure, and/or the like. Based on the circumstance parameter(s) of the instance of radio data captured at location 310J, the network device 10 may determine that the velocity or acceleration experienced by the mobile device 20 indicates mobile device 20 is likely inside a motorized vehicle (e.g., passenger vehicle, public transportation bus, and/or the like).

In various embodiments, the circumstance parameters and/or instances of location data for multiple instances of radio data of the plurality and/or (time-ordered) sequence of instances of radio data may be considered in concert to determine a context for one or more instances of radio data. For example, if the circumstance parameters and/or instances of location data indicate that the mobile device 20 was following a known public bus route and stopped at various known bus stops along the known public bus route, it may be determined that the corresponding instances of radio data (e.g., the instances of radio data captured at locations 310I, 310J) were captured onboard a public transportation bus. For example, if the circumstance parameters and/or instances of location data indicate that the mobile device 20 was not following a known public bus route and/or did not stop at various known bus stops along the known public bus route, it may be determined that the corresponding instances of radio data (e.g., the instances of radio data captured at locations 310I, 310J) were captured onboard a passenger vehicle (e.g., a car, truck, van, and/or the like).

In various embodiments, a context is determined for each instance of radio data. The plurality and/or (time-ordered) sequence of instances of radio data may then be partitioned into consecutive groups of instances of radio data that have the same context. For example, continuing to refer to FIG. 3, the instances of radio data captured at locations 310B-G are consecutive instances of radio data that are all associated with the context of being captured onboard a train. Therefore, it is likely that each of the instances of radio data captured at locations 310B-G were captured on the same train, in the same train car, and/or the like. Therefore, it is expected that signal attenuation and/or amplification that occurred when the instance of radio data was captured at location 310B will be similar as the signal attenuation and/or amplification that occurred when the respective instances of radio data were captured at locations 310C-G. As used herein, consecutive instances of radio data are instances of radio data that are associated with consecutive time stamps. For example, for a sequence of three instances of radio data, a first instance of radio data is associated with timestamp t₁, a second instance of radio data is associated with timestamp t₂, and a third instance of radio data is associated with timestamp t₃, with t₁<t₂<t₃. A group comprising the first instance of radio data and the second instance of radio data, but not the third instance of radio data is a consecutive group of instances of radio data. Similarly, a group comprising the second instance of radio data and the third instance of radio data, but not the first instance of radio data is a consecutive group of instances of radio data. However, a group comprising the first instance of radio data and the third instance of radio data, but not the second instance of radio data is not a consecutive group of instances of radio data. Additionally, a group comprising the first, second, and third instances of radio data is a consecutive group of instances of radio data.

Continuing with FIG. 5, at block 506, a network device 10 determines a reference signal characteristic (e.g., reference signal strength) for a first location. For example, the network device 10 comprises means, such as processor 12, memory 14, and/or the like, for determining a reference signal characteristic for the first location. In various embodiments, a first group is a consecutive group of instances of radio data captured under a first context and the first group comprises a first instance of radio data comprising a first instance of location data indicating a first location. The first instance of radio data includes a first instance of radio observation data that indicates an observed signal characteristic for a first radio node. A reference signal characteristic (e.g., a reference signal strength) is determined for the first radio node at the first location. In an example embodiment, the reference signal characteristic is a signal characteristic of a signal emitted, broadcasted, generated, and/or transmitted by the first radio node and measured at a location that is within a set distance D of the first location. The set distance D is determined and/or set such that the signal characteristic corresponding to the first radio node at a location a set distance D from the first location is expected to be substantially the same as at the first location (e.g., within 10%, within 5%, within 2.5%, within 1%, and/or the like of the signal characteristic at the first location). In various embodiments, the reference signal characteristic for the first radio node at the first location is determined based on a radio map. For example, a radio map may include information regarding a measured and/or predicted signal characteristic (e.g., signal strength) of the first radio node at a location within the set distance D of the first location and the network device 10 may access the reference signal characteristic for the first radio node at the first location from the radio map. In another example, the plurality and/or sequence of instances of radio data may include a second instance of radio data comprising a second instance of location data indicating a second location that is within the set distance D of the first location and at this associated with a second context. When the second context is no mobile structure (and the first context indicates the mobile device was located within some kind of mobile structure when the corresponding instance of radio observation data was captured), a signal characteristic for the first radio node indicated by the second instance of radio observation data of the second instance of radio data is used as the reference signal characteristic for the first radio node at the first location, in an example embodiment. In various embodiments, reference signal characteristics may be determined for two or more radio nodes at the first location.

At block 508, the network device 10 determines a first signal strength correction corresponding to the first context. For example, the network device 10 comprises means, such as processor 12, memory 14, and/or the like, for determining a first signal strength correction corresponding to the first context. For example, the first instance of radio data, captured at the first location and associated with a first context, includes a first instance of radio observation data including an observed signal characteristic (e.g., observed signal strength) for the first radio node, denoted herein as O₁. At block 506, a reference signal characteristic (e.g., reference signal strength) corresponding to the first location (e.g., within a set distance D of the first location) and corresponding to the first radio (denoted herein as R₁) node was determined. In various embodiments, the first strength correction corresponding to the first context, denoted herein as C, is determined based on the difference between the reference signal characteristic for the first radio node corresponding to the first location and the observed signal characteristic at the first location for the first radio node (e.g., C=O₁−R₁).

In various instances, the first instance of radio data includes observed signal characteristics at the first location for a plurality of radio nodes. In various instances, reference signal characteristics for the first location are available (e.g., based on a radio map, a second instance of radio data corresponding to a second location within a set distance D of the first location and associated with a context of no mobile structure, and/or the like) for two or more radio nodes of the plurality of radio nodes. In an example embodiment, a signal characteristic correction C′ for the first context is determined for each of the two or more radio nodes (e.g., Cⁱ=O₁ⁱ−R₁ⁱ, for the i^{th} radio node of the two or more radio nodes). In an example embodiment, the first signal characteristic correction is determined based on a statistical analysis of the signal characteristic corrections Cⁱ determined for the two or more radio nodes. For example, the first signal characteristic correction is determined by averaging the signal characteristic corrections Cⁱ for the two or more radio nodes, in an example embodiment. For example, the first signal characteristic correction is the average of the signal characteristic corrections for the first location for two or more radio nodes, in an example embodiment. In various embodiments, the first signal characteristic correction is determined based on the signal characteristic corrections for the two or more radio nodes regardless of the frequency bands and/or radio type (e.g., Wi-Fi, Bluetooth, 5G NR, LTE, cellular, and/or the like) of the two or more radio nodes.

In an example embodiment, a first signal characteristic correction for the first context is determined for a particular radio type or frequency band. For example, each of the two or more radio nodes are configured to emit, broadcast, transmit, and/or generate radio signals of respective radio types (e.g., Wi-Fi, Bluetooth, 5G NR, LTE, cellular, and/or the like) and of respective frequency bands. In an example embodiment, a first signal characteristic correction is determined for each radio type and/or frequency band corresponding to the two or more radio nodes for the first context. For example, the two or more radio nodes may include a Wi-Fi radio node and a Bluetooth radio node. Thus, in an example embodiment, a Wi-Fi signal characteristic correction and a Bluetooth signal characteristic correction are determined for the first context.

At block 510, the network device 10 generates and/or determines corrected signal characteristics (e.g., corrected signal strengths) for the instances of radio data of the first group (e.g., the consecutive group of instances of radio data captured under and/or associated with the first context). For example, the network device 10 comprises means, such as processor 12, memory 14, and/or the like, for generating and/or determining corrected signal characteristics for the instances of radio data of the first group. For example, the first group includes a i^{th} instance of radio data that includes a i^{th} instance of radio observation data including a respective observed signal characteristic for one or more radio nodes. The signal characteristic correction for the first context is used to determine a respective corrected signal characteristic for one or more radio nodes for which respective observed signal characteristics are provided by the j^{th} instance of radio observation data. For example, a corrected signal characteristic S for a particular radio node corresponding to a particular instance of radio data (e.g., corresponding to a particular location indicated by the particular instance of location data of the particular instance of radio data) is determined by subtracting the signal characteristic correction C for the context corresponding to the particular instance of radio data from the observed signal characteristic O of the particular instance of radio observation data of the particular instance of radio data (e.g., S=O−C). In various embodiments, a corrected signal characteristic (e.g., corrected signal strength) is determined for each instance of radio data of the first group.

In an example embodiment, the signal characteristic correction is applied to the observed signal characteristics to generate corrected signal characteristics regardless of the radio type and/or frequency band of the corresponding radio node. For example, a signal characteristic correction determined based on a reference signal characteristic and an observed signal characteristic corresponding to a first radio node may be used to generate and/or determine a corrected signal characteristic corresponding to a second radio node. The first radio node and the second radio node correspond to a same radio type and/or frequency band, in various embodiments. In an example embodiment, the first radio node and the second radio node may correspond to the same or different radio types and/or frequency bands. In an example embodiment, a respective radio type and/or respective frequency band specific signal characteristic correction is applied to observed signal characteristics to generate corrected signal characteristics corresponding to the respective radio type and/or respective frequency band. For example, in an example embodiment, the corrected signal characteristics corresponding to radio nodes of the radio type Wi-Fi are determined using a Wi-Fi specific signal characteristic correction and the corrected signal characteristics corresponding to radio nodes of the radio type 5G NR are determined using a 5G NR specific signal characteristic correction. In an example embodiment, when a radio type and/or frequency band specific signal characteristic correction is not available for a particular radio type and/or frequency band, information regarding observed signal characteristics for radio nodes of the particular radio type and/or frequency band are stored (e.g., in memory 14) for later processing and/or analysis (e.g., when a corresponding radio type and/or frequency band specific reference signal characteristic and/or signal characteristic correction is available).

At block 512, in various embodiments, the network device 10 generates and/or updates a radio map based on the corrected signal strengths. For example, the network device 10 comprises means, such as processor 12, memory 14, and/or the like, for generating and/or updating a radio map based on the corrected signal strengths. For example, each corrected signal characteristic is associated with the instance of location data corresponding to the instance of radio data from which the corrected signal characteristic was generated and/or determined. For example, each corrected signal characteristic is associated with a radio node identifier indicated in the instance of radio observation data corresponding to the instance of radio data from which the corrected signal characteristic was generated and/or determined. Thus, in various embodiments, the radio map is generated and/or updated to indicate that a particular radio node was observed at a particular location to have a particular signal characteristic (e.g., particular signal strength), where the particular signal characteristic is the corrected signal characteristic, the particular radio node is identified by the corresponding radio node identifier and the particular location is indicated by the corresponding instance of location data.

In an example embodiment, the network device 10 generates and/or updates context-specific radio maps. For example, the network device 10 comprises means, such as processor 12, memory 14, and/or the like, for generating and/or updating context-specific radio maps. For example, the observed signal characteristics from instances of radio data associated with a first context may be used to generate and/or update a first context-specific radio map while the observed signal characteristics from instances of radio associated with a second context may be used to generate and/or update a second context-specific radio map. The context-specific radio maps may then be used for performing context-specific positioning (e.g., determining a position estimate for a computing entity 50 known to be under a corresponding context) and/or used to determine a context for a mobile device 20 and/or computing entity 50 (e.g., based on matching one or more instances of radio observation data captured by the mobile device 20 and/or computing entity 50 to a pattern of expected observations indicated by the context-specific radio map). For example, the context-specific radio map corresponding to a particular model of train car may be configured for use by computing entities 50 onboard train cars of the particular model (e.g., to perform positioning and/or other positioning and/or navigation-related functions) and/or to identify when the computing entity 50 is onboard a train car of the particular model.

At block 514, in various embodiments, the network device 10 stores and/or provides at least a portion of the radio map. For example, the network device 10 comprises means, such as processor 12, memory 14, communications interface 16, and/or the like, for storing and/or providing at least a portion of the radio map. For example, the network device 10 may store the radio map and/or a portion thereof in memory 14 for later use, updating, and/or the like. For example, the network device 10 may provide (e.g., transmit) at least a portion of the radio map such that a computing entity 50 and/or other computing device receives the radio map. For example, the radio map may be used (e.g., by the network device 10, computing entity 50, and/or the like) for performing one or more positioning and/or navigation-related functions. For example, some non-limiting examples of positioning and/or navigation-related functions include determining a position estimate, route calculation, route guidance, map display, speed calculation, distance and travel time functions, and other functions. The navigation-related functions can correspond to vehicle navigation or other types of navigation.

At block 516, in various embodiments, the network device 10 generates, updates, and/or stores a context-specific aggregated signal characteristic correction and/or signal characteristic correction distribution. For example, the network device 10 comprises means, such as processor 12, memory 14, and/or the like, for generating, updating, and/or storing a context-specific aggregated signal characteristic correction and/or signal characteristic correction distribution. For example, the determined signal characteristics correction may be stored to signal characteristic distribution for the corresponding context. In an example embodiment, the context-specific aggregated signal characteristic correction and/or context-specific signal characteristic correction distribution is radio type and/or frequency band specific. In an example embodiment, the context-specific aggregated signal characteristic correction and/or context-specific signal characteristic distribution is configured for use in performing a positioning and/or navigation-related function for a computing entity 50 experiencing a particular context using the radio map. In an example embodiment, when the context-specific signal characteristic correction distribution is uni-modal, it may be determined that the average of the distribution and/or another value representative of the distribution is a good estimate of the signal characteristic correction for the corresponding context. When the context-specific signal characteristic correction distribution is multi-modal, it may be determined that the context-specific signal characteristic distribution should be broken into radio type and/or frequency band specific distributions, that the corresponding context is not specific enough to globally characterize the attenuation and/or amplification of radio signals by a corresponding mobile structure (e.g., different models of train cars may provide different attenuation and/or amplification and the context would need to be determined down to the train car model to be widely applicable), and/or the like.

As noted above, a plurality and/or (time-ordered) sequence of instances of radio data may be partitioned into consecutive groups, where a consecutive group includes a time-ordered sequence of consecutively captured instances of radio data that were all captured under the same context. A respective signal characteristic correction (and/or respective radio type and/or frequency band specific signal characteristic corrections) may be determined for one or more of the consecutive groups and corrected signal characteristics for instances of radio data of a respective group may be determined based on the respective signal characteristic correction(s) for that consecutive group, in various embodiments.

### C. Example Operation of a Network Device to Determine a Reference Signal Characteristic

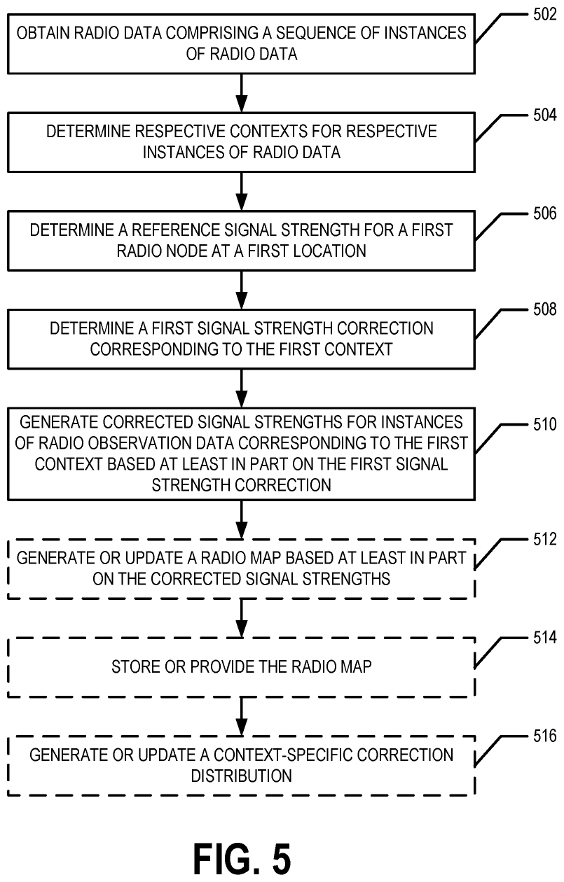

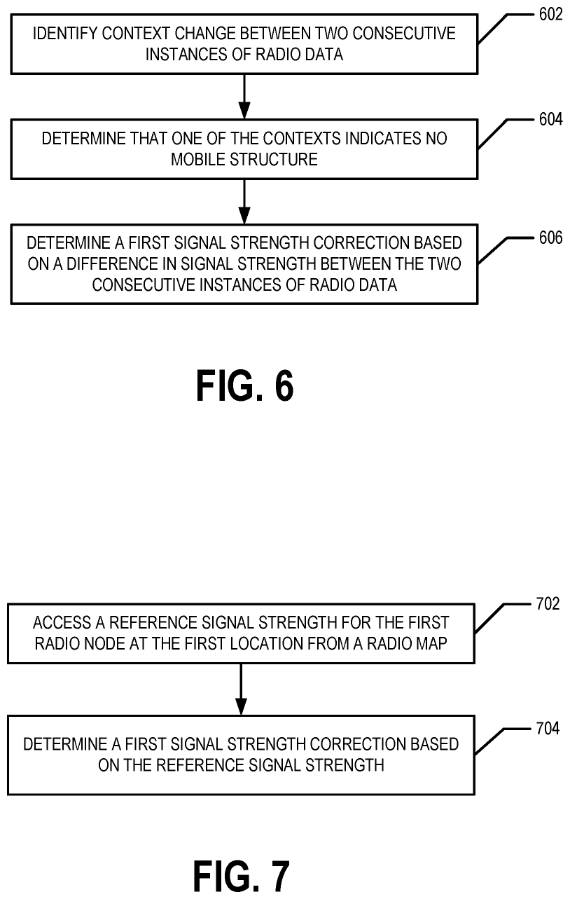

FIGS. 6 and 7 illustrate processes, procedures, operations, and/or the like for various techniques for determining a reference signal characteristic for a first radio node at a first location. For example, FIG. 6 provides a flow chart illustrating various processes, procedures, operations, and/or the like for determining a reference signal characteristic for a first radio node at a first location based on a second instance of radio data of the plurality and/or (time-ordered) sequence of instances of radio data. For example, a second instance of radio data of the plurality and/or (time-ordered) sequence of instances of radio data that is associated with a context indicating no mobile structure and that includes a second instance of location data indicating a second location that is within the set distance D of the first location is identified. The second instance of radio data includes a second observed signal characteristic for a first node. In an example embodiment, the second observed signal characteristic for the first node is then used as the reference signal characteristic for the first radio node at the first location, in an example embodiment. For example, the processes, procedures, and/or operations illustrated in FIG. 6 may occur as part of block 506 and/or 508, in an example embodiment.

Starting at block 602, the network device 10 identifies a change in context between two consecutive instances of radio data. For example, the network device 10 comprises means, such as processor 12, memory 14, and/or the like for identifying a change in context between two consecutive instances of radio data. For example, the two consecutive instances of radio data are expected to be associated within respective instances of location data indicating respective locations that are near one another (e.g., possibly within the set distance D of one another). When the context changes between two consecutive instances of radio data, it is possible that the context associated with one of the two consecutive instances of radio data indicates no mobile structure (e.g., the mobile device 20 was between mobile structures, for example).

At block 604, the network device 10 determines that one of the two consecutive instances of radio data and/or determines which of the two consecutive instances of radio data is associated with a context indicating no mobile structure. For example, the network device 10 comprises means, such as processor 12, memory 14, and/or the like for determining that one of the two consecutive instances of radio data and/or determining which of the two consecutive instances of radio data is associated with a context indicating no mobile structure. For example, the two consecutive instances of radio data comprises a first instance of radio data and a second instance of radio data. It is determined that the second instance of radio data is associated with a context of no mobile structure and the second location of the second instance of radio data is within the set distance D of the first location of the first instance of radio data.

At block 606, the network device 10 uses the observed signal characteristic for a first radio node of the second instance of radio observation data of the second instance of radio data as a reference signal characteristic to determine a signal characteristic correction (at least for a radio type and/or frequency band corresponding to the first radio node) based on the observed signal characteristic for the first radio node of the first instance of radio observation data of the first instance of radio data. For example, the network device 10 comprises means, such as processor 12, memory 14, and/or the like, for using the observed signal characteristic for a first radio node of the second instance of radio observation data of the second instance of radio data as a reference signal characteristic to determine a signal characteristic correction (at least for a radio type and/or frequency band corresponding to the first radio node) based on the observed signal characteristic for the first radio node of the first instance of radio observation data of the first instance of radio data. For example, the signal characteristic correction (at last for a radio type and/or frequency band corresponding to the first radio node) is determined based at least in part on the difference between the observed signal characteristic for the first node according to the second instance of radio data and the observed signal characteristic for the first node according to the first instance of radio data.

FIG. 7 provides a flow chart illustrating various processes, procedures, operations, and/or the like for determining a reference signal characteristic for a first radio node at a first location based on a radio map. For example, the processes, procedures, and/or operations illustrated in FIG. 7 may occur as part of block 506 and/or 508, in an example embodiment.

Starting at block 702, the network device 10 access a radio map is accessed and determines an expected signal characteristic (e.g., expected signal strength) for a first radio node at a first location based on the radio map. For example, the network device 10 comprises means, such as processor 12, memory 14, and/or the like, for accessing a radio map and determining an expected signal strength for a first radio node at the first location based on the radio map. For example, based on the first radio node identifier provided by the first instance of radio observation data, the network device 10 may query the radio map to identify a radio model corresponding to the first radio node identified by the first radio node identifier. Based on the radio model, an expected signal characteristic of the first radio node at the first location is determined. For example, an expected signal characteristic of the first radio node at the first location may be calculated and/or computed based on the radio model. For example, the radio model may include at least one measured value for the signal characteristic of the first radio node at a location within the set distance D of the first location and the at least one measure value is used as the expected signal characteristic of the first radio node at the first location.

At block 704, the network device 10 uses the expected signal characteristic for the first radio node as a reference signal characteristic to determine a signal characteristic correction (at least for a radio type and/or frequency band corresponding to the first radio node) based on the observed signal characteristic for the first radio node of the first instance of radio observation data of the first instance of radio data. For example, the network device 10 comprises means, such as processor 12, memory 14, and/or the like, for using the expected signal characteristic for a first radio node as a reference signal characteristic to determine a signal characteristic correction (at least for a radio type and/or frequency band corresponding to the first radio node) based on the observed signal characteristic for the first radio node of the first instance of radio observation data of the first instance of radio data. For example, the signal characteristic correction (at last for a radio type and/or frequency band corresponding to the first radio node) is determined based at least in part on the difference between the expected signal characteristic for the first node according to the radio map and the observed signal characteristic for the first node according to the first instance of radio data.

### D. Example Operation of a Computing Entity

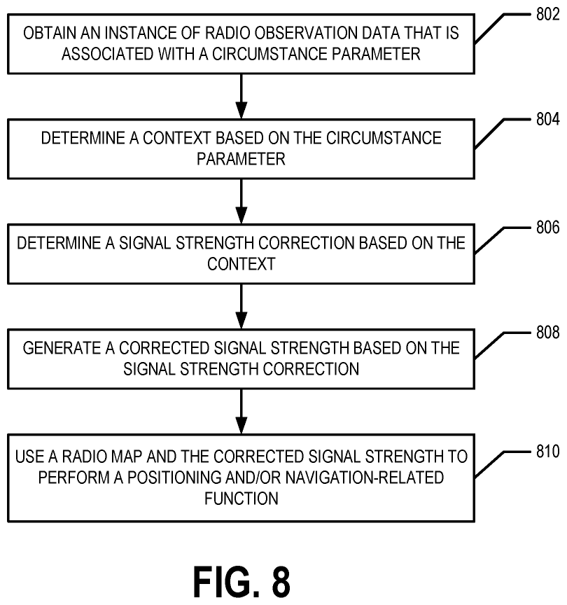

In various embodiments, a computing entity 50 captures an instance of radio observation data and one or more circumstance parameters and, based on the instance of radio observation data and the one or more circumstance parameters, determines a corrected signal characteristic corresponding to the instance of radio observation data that is used, in coordination with a radio map, to perform one or more positioning and/or navigation-related functions. Accordingly, FIG. 8 provides a flowchart illustrating various processes, procedures, and/or operations performed, for example, by a network device 10 and/or computing entity 50 to determine a position estimate for the computing entity 50.

Starting at block 802, an instance of radio observation data that is associated with at least one circumstance parameter is obtained. For example, a network device 10 may receive (e.g., via network 60) and/or access from memory (e.g., memory 14) an instance of radio observation data and an associated at least one circumstance parameter. For example, a computing entity 50 may capture and/or generate an instance of radio observation data and an associated at least one circumstance parameter. For example, the network device 10 and/or computing entity 50 may comprise means, such as processor 12, 52, memory 14, 54, communications interface 16, 56, and/or the like, for the network device 10 and/or computing entity 50 to obtain an instance of radio observation data and an associated at least one circumstance parameter. In various embodiments, an instance of radio observation data characterizes the observation of one or more radio signals by the mobile device that captured the instance of radio data. For example, an instance of radio observation data includes information identifying a radio node (e.g., a radio node identifier such as a media access control (MAC) address, a global system/standard for mobile communication(s) (GSM) cell identifier, and/or the like), a radio type of the radio node (e.g., cellular, Wi-Fi, Bluetooth, and/or the like), a signal frequency and/or frequency-band, an observed signal characteristic (e.g., an observed signal strength), and/or the like. In various embodiments, a circumstance parameter characterizes the motion state and/or at least a portion of the environment about the mobile device when the mobile device captured the corresponding instance of radio observation data. For example, the at least one circumstance parameter may include audio data, acceleration data, velocity data, heading data, barometer data, and/or the like.

At block 804, the network device 10 and/or the computing entity 50 determines a context based on the at least one circumstance parameter. For example, the network device 10 and/or computing entity 50 comprises means, such as processor 12, memory 14, and/or the like for determining a context based on the at least one circumstance parameter. For example, the at least one circumstance parameter may be analyzed and/or processed to determine a context. In various embodiments, the context associated with an instance of radio observation data corresponds to a respective type of mobile structure the computing entity 50 was located in when the computing entity 50 captured the instance of radio observation data. The respective type of mobile structure is one of no mobile structure, train (e.g., commuter train, inter-city train, intra-city train, subterranean train, above ground train, and/or the like), train type, train model, a particular train car, tram, car, bus (e.g., public transportation bus, inter-city bus, intra-city bus), airplane, boat, market booth, temporary outdoor venue (e.g., concert venue, convention venue, and/or the like), fair structure, or other mobile (e.g., movable and/or temporary) structure, in an example embodiment.

At block 806, the network device 10 and/or computing entity 50 determines a signal characteristic correction (e.g., a signal strength correction) based on the context. For example, the network device 10 and/or computing entity 50 comprises means, such as processor 12, 52, memory 14, 54, communications interface 16, 56, and/or the like, for determining a signal characteristic correction based on the context. In an example embodiment, the one or more radio type and/or frequency band specific signal characteristic corrections are determined based on the context. In an example embodiment, the signal characteristic correction is determined based on a context-specific aggregated signal characteristic correction and/or a context-specific signal characteristic correction distribution that is stored and/or maintained by the network device 10, for example. In various embodiments, a signal characteristic correction is determined based on the context in a manner similar to that described with respect to FIG. 6 and/or FIG. 7.

At block 808, the network device 10 and/or computing entity 50 determines a corrected signal characteristic (e.g., corrected signal strength) based on the signal characteristic correction (e.g., signal strength correction) and the observed signal characteristic (e.g., observed signal strength) of the instance of radio observation data. For example, the network device 10 and/or the computing entity 50 comprise means, such as processor 12, 52, memory 14, 54, and/or the like, for determining a corrected signal characteristic (e.g., corrected signal strength) based on the signal characteristic correction (e.g., signal strength correction) and the observed signal characteristic (e.g., observed signal strength) of the instance of radio observation data. For example, the signal characteristic correction may be added to or subtracted from the observed signal characteristic, as appropriate for the definition of the signal characteristic correction, to determine the corrected signal characteristic. In various embodiments, the signal characteristic correction is an offset value between the observed signal characteristic and the actual and/or expected signal characteristic at a location due to attenuation and/or amplification of the observed radio signal by a mobile structure.

At block 810, the network device 10 and/or computing entity 50 determines a position estimate for the computing entity 50 when the computing entity 50 captured the instance of radio observation data and the associated at least one circumstance parameter based on the corrected signal characteristic and a radio map. For example, the network device 10 and/or computing entity 50 may comprise means, such as processor 12, 52, memory 14, 54, and/or the like, for determining a position estimate for the computing entity 50 when the computing entity 50 captured the instance of radio observation data and the associated at least one circumstance parameter based on the corrected signal characteristic and a radio map.

For example, the radio map and the corrected signal characteristic may be used to perform one or more positioning and/or navigation-related functions. For example, some non-limiting examples of positioning and/or navigation-related functions include determining a position estimate, route calculation, route guidance, map display, speed calculation, distance and travel time functions, and other functions. The navigation-related functions can correspond to vehicle navigation or other types of navigation. For example, a position estimate for the location of the computing entity 50 may be determined based on the radio map and the corrected signal characteristic (e.g., using a radio-based positioning technique). Based on the determined position estimate, route guidance, map display centered on the position estimate, maneuver guidance, and/or speed calculation may be performed, to name a few examples.

In various embodiments, the network device 10 may use the corrected signal characteristic to update a radio map. For example, the network device 10 may comprise means, such as processor 12, memory 14, and/or the like to update a radio map based on the corrected signal characteristic. For example, the instance of radio observation data may also be associated with an instance of location data determined by GNSS-based positioning, IMU and/or motion-based positioning, hybrid positioning (e.g., using a combination of GNSS-based, radio-based, IMU and/or motion-based, and/or other positioning techniques), and/or the like. For example, the network device 10 may update the radio map by including the corrected signal characteristic as part of a radio model for a corresponding radio node at the location indicated by the associated instance of location data. In another example, the network device 10 may compare the position estimate determined based on the corrected signal characteristic and the radio map to the location indicated by the associated instance of location data to determine an accuracy of the radio map and/or determination of the corrected signal characteristic. In an example embodiment, the radio map, context determination process, and/or the context-specific signal characteristic correction distribution may be updated to aid in improving the accuracy of position estimates generated based on the radio map and corrected signal characteristics.

### III. Technical Advantages

Various embodiments provide technical solutions to the technical problems of correcting observed signal characteristics (observed signal strengths) of radio signals for the effects (attenuation and/or amplification) caused by mobile structures. For example, when a mobile device and/or computing entity is located within a mobile structure (e.g., a train), the mobile device and/or computing entity may observe radio signals that are attenuated and/or amplified by the mobile structure. Thus, the signal characteristics observed by the mobile device and/or computing entity is offset from the actual signal characteristic at the same location when the mobile structure is not present. In other words, if the mobile device or computing entity were located at the same location but not within the mobile structure, the mobile device or computing entity would observe a different (e.g., an offset) signal characteristic. Therefore, using the observed signal characteristics to update a radio map may cause the radio map to be inaccurate and/or may introduce extra noise into radio models of the radio map that are used to describe respective radio node coverage areas and/or expected radio signal characteristics corresponding to respective radio nodes. Thus a technical problem exists as to how to reduce the noise introduced into the radio map by using observed signal characteristics to update the radio map (e.g., using crowd-sourcing).

Various embodiments provide technical solutions to these technical problems by grouping instances of radio data based on context, determining context-specific signal characteristic corrections, and determining corrected signal characteristics using the context-specific characteristic corrections. By updating the radio map based on the corrected signal characteristics, the noise introduced into the radio map by crowd-sourced radio data that may or may not correspond to mobile structures is mitigated and/or reduced and the radio map may provide for more accurate positioning. Therefore, various embodiments provide improvements to the field of radio-based positioning and radio map generation.

### IV. Example Apparatus

The network device 10, mobile device 20, and/or computing entity 50 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, and/or other device that can observe the radio environment (e.g., receive radio frequency signals from network access points and/or other radio nodes) in the vicinity of the computing device and/or that can store at least a portion of a positioning map. Additionally or alternatively, the network device 10, mobile device 20, and/or computing entity 50 may be embodied in other types of computing devices, such as a server, a personal computer, a computer workstation, a laptop computer, a plurality of networked computing devices or the like, that are configured to capture and provide instances of radio data, determine respective contexts under which instances of radio data were captured, determine reference signal characteristics and context-specific signal characteristic corrections, generate corrected signal characteristics, use corrected signal characteristics to generate and/or update a radio map, and/or the like. In an example embodiment, a mobile device 20 and/or computing entity 50 is a smartphone, tablet, laptop, PDA, and/or other mobile computing device and a network device 10 is a server that may be part of a Cloud-based computing asset and/or processing system.

In some embodiments, the processor 12, 22, 52 (and/or co-processors or any other processing circuitry assisting or otherwise associated with the processor) may be in communication with the memory device 14, 24, 54 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network device 10, mobile device 20, and/or computing entity 50 may be embodied by a computing device. However, in some embodiments, the network device 10, mobile device 20, and/or computing entity 50 may be embodied as a chip or chip set. In other words, the network device 10, mobile device 20, and/or computing entity 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 52 may be embodied in a number of different ways. For example, the processor 12, 22, 52 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22, 52 may include one or more processing cores configured to perform independently. A multi-core processor may enable multiprocessing within a single physical package. Additionally or alternatively, the processor 12, 22, 52 may include one or more processors configured in tandem via the bus to enable independent execution of instructions, pipelining and/or multithreading.

In an example embodiment, the processor 12, 22, 52 may be configured to execute instructions stored in the memory device 14, 24, 54 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network device 10, mobile device 20, and computing entity 50 may include a user interface 18, 28, 58 that may, in turn, be in communication with the processor 12, 22, 52 to provide output to the user, such as one or more navigable routes to a destination location and/or from an origin location, display of location dependent and/or triggered information, and/or the like, and, in some embodiments, to receive an indication of a user input. As such, the user interface 18, 28, 58 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 52 (e.g., memory device 14, 24, 54 and/or the like).

The network device 10, mobile device 20, and/or computing entity 50 may optionally include a communication interface 16, 26, 56. The communication interface 16, 26, 56 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network device 10, mobile device 20, and/or computing entity 50 may comprise a component (e.g., memory 14, 24, 50, and/or another component) that stores a digital map (e.g., in the form of a geographic database) comprising a first plurality of data records, each of the first plurality of data records representing a corresponding traversable map element (TME). At least some of said first plurality of data records map information/data indicate current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a positioning map comprising an access point registry and/or instances of network access point information corresponding to various network access points. For example, a geographic database may include road segment, segment, link, lane segment, or TME data records, point of interest (POI) data records, localization feature data records, radio node and/or radio model records, and other data records. In an example embodiment, the geographical database is and/or comprises a radio map configured to enable radio-based positioning within a corresponding geographic region. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, radio node and/or radio model records, and/or other data records. In an example embodiment, the network device 10 may be configured to modify, update, and/or the like one or more data records of the geographic database. For example, the network device 10 may modify, update, generate, and/or the like map information/data corresponding to TMEs, links, lanes, road segments, travel lanes of road segments, nodes, intersection, pedestrian walkways, elevators, staircases, radio nodes, radio models, and/or the like and/or the corresponding data records (e.g., to add or update updated map information/data including, for example, current traffic conditions along a corresponding TME), a localization layer (e.g., comprising localization features), a registry of access points to identify mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

### V. Apparatus, Methods, and Computer Program Products

As described above, FIGS. 4, 5, 6, 7, and 8 illustrate flowcharts of a network device 10, mobile device 20 and/or computing entity 50, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 50 of an apparatus employing an embodiment of the present invention and executed by the processor 12, 22, 52 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining radio data generated by a mobile device, wherein:
the radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data,
each instance of radio observation data of the plurality of instances of radio observation data indicates a respective observed signal strength of a respective at least one radio node,
each respective instance of location data of the plurality of instances of location data indicates a respective location of the mobile device when the mobile device captured an associated instance of radio observation data,
each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data, and
the radio data comprises a first instance of radio observation data associated with a first instance of location data and a first circumstance parameter, the first instance of radio observation data indicating a first observed signal strength of at least one first radio node at a first location indicated by the first instance of location data while the mobile device was at least one of moving with a characteristic of motion and/or experiencing an environment indicated by the first circumstance parameter;
based on at least one of the first circumstance parameter or the first location, determining a first context indicating a context under which the first instance of radio observation data was captured;
based at least on the first location, determining a reference signal strength of the at least one first radio node at the first location;
based on the reference signal strength and the first observed signal strength of the at least one first radio node, determining a first signal strength correction corresponding to the first context; and
generating one or more corrected signal strengths by adjusting one or more observed signal strengths of the plurality instances of radio observation data respectively associated with the first context using the first signal strength correction, each corrected signal strength of the one or more corrected signal strengths associated with a respective instance of location data of the plurality of instances of location data.

2. The method of claim 1 further comprising:
generating or updating a radio map based on the one or more corrected signal strengths and the associated respective instances of location data; and
storing and/or providing the radio map for at least use in performing one or more positioning and/or navigation-related functions.

3. The method of claim 2, wherein the radio map is specific to the first context.

4. The method of claim 1, wherein the context under which the first instance of radio observation data was captured indicates at least one of (a) a mobility state of the mobile device when the first instance of radio observation data was captured or (b) a type of mobile structure that the mobile device was located within when the first instance of radio observation data was captured.

5. The method of claim 1, wherein the reference signal strength is accessed from a radio map based on the first location and an identifier of the at least one first radio node.

6. The method of claim 1, wherein the reference signal strength is determined at least in part based on the first instance of radio observation data and a second instance of radio observation data of the plurality of instances of radio observation data, the second instance of radio observation data is associated with a second instance of location data indicating a second location located within a set distance of the first location, the second instance of radio observation data is associated with a second context that is different from the first context.

7. The method of claim 6, wherein the signal strength correction is a difference between the first observed signal strength of the at least one first radio node as indicated by the first instance of radio observation data and a second observed signal strength of the at least one first radio node as indicated by the second instance of radio observation data.

8. The method of claim 1, further comprising based on at least one of a respective circumstance parameter or a respective location indicated by a respective instance of location data, determining a respective context for each instance of radio observation data of the plurality instances of radio observation data.

9. The method of claim 8, wherein the respective context corresponds to a respective type of mobile structure that the mobile device was located within when the respective instance of radio data was captured, the respective type of mobile structure being one of no mobile structure, train, train type, train model, a particular train car, tram, car, bus, airplane, boat, market booth, temporary outdoor venue, or fair structure.

10. The method of claim 1, wherein the plurality of instances of radio observation data comprises a first group of consecutive instances of radio observation data that are associated with the first context and a second group of consecutive instances of radio observation data that are associated with a second context, the first signal strength correction is used to generate corrected signal strengths corresponding to the instances of radio observation data of the first group, and a second signal strength correction is determined and used to generate corrected signal strengths corresponding to the instances of radio observation data of the second group.

11. The method of claim 1, wherein the first instance of radio observation data indicates respective first observed signal strengths for a first radio node and a second radio node, and at least one of:
when respective reference signal strengths at the first location are available for both the first radio node and the second radio node, the first signal strength correction is determined based on a combination of the respective first observed signal strengths and the respective reference signal strengths for both the first radio node and the second radio node,
when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node regardless of respective transmission frequencies or transmission channels of the first and second radio node, or
when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node only when the first and second radio node are associated with a same transmission frequency or transmission channel.

12. The method of claim 1, wherein when a second instance of radio observation data indicates a second observed signal strength of a second radio node and the second instance of radio observation data is associated with the first context, the first signal strength correction and the second observed signal strength are used to generate a corrected signal strength at a second location for the second radio node, the second location indicated by a second instance of location data associated with the second instance of radio observation data.

13. A method comprising:
obtaining an instance of radio observation data indicating an observed signal strength of at least one radio node observed by a mobile device and associated with a circumstance parameter indicating at least one of a characteristic of motion of the mobile device or a characteristic of at least a portion of the environment about the mobile device when the instance of radio observation data was captured;
determining, based at least in part on the circumstance parameter, a context associated with the instance of radio observation data;
determining, based at least in part on the context, a signal strength correction;
generating a corrected signal strength of the at least one radio node based on the observed signal strength of the at least one radio node and the signal strength correction; and
based at least in part on the corrected signal strength of the at least one radio node, (i) determining at least one position of the mobile device or (ii) generating and/or updating a radio map.

14. An apparatus comprising at least one processor and at least one memory storing computer program instructions, the at least one memory and the computer program code are configured to, with the processor, cause the apparatus to at least:
obtain radio data generated by a mobile device, wherein:
the radio data comprises (a) a plurality of instances of radio observation data, (b) a plurality of instances of location data, each instance of location data of the plurality of instances of location data associated with a respective instance of radio observation data of the plurality of instances of radio observation data, and (c) a plurality of circumstance parameters, each circumstance parameter of the plurality of circumstance parameters associated with a respective instance of radio observation data of the plurality of instances of radio observation data,
each instance of radio observation data of the plurality of instances of radio observation data indicates a respective observed signal strength of a respective at least one radio node,
each respective instance of location data of the plurality of instances of location data indicates a respective location of the mobile device when the mobile device captured an associated instance of radio observation data,
each circumstance parameter of the plurality of circumstance parameters is generated based on sensor data captured by one or more sensors of the mobile device and indicates at least one of a characteristic of motion of the mobile device or a characteristic of at least a portion of the environment about the mobile device when the mobile device captured the associated instance of radio observation data, and
the radio data comprises a first instance of radio observation data associated with a first instance of location data and a first circumstance parameter, the first instance of radio observation data indicating a first observed signal strength of at least one first radio node at a first location indicated by the first instance of location data while the mobile device was at least one of moving with a characteristic of motion and/or experiencing an environment indicated by the first circumstance parameter;
based on at least one of the first circumstance parameter or the first location, determining a first context indicating a context under which the first instance of radio observation data was captured;
based at least on the first location, determine a reference signal strength of the at least one first radio node at the first location;
based on the reference signal strength and the first observed signal strength of the at least one first radio node, determine a first signal strength correction corresponding to the first context; and
generate one or more corrected signal strengths by adjusting one or more observed signal strengths of the plurality instances of radio observation data respectively associated with the first context using the first signal strength correction, each corrected signal strength of the one or more corrected signal strengths associated with a respective instance of location data of the plurality of instances of location data.

15. The apparatus of claim 14, wherein the context under which the first instance of radio observation data was captured indicates at least one of (a) a mobility state of the mobile device when the first instance of radio observation data was captured or (b) a type of mobile structure that the mobile device was located within when the first instance of radio observation data was captured.

16. The apparatus of claim 14, wherein the reference signal strength is accessed from a radio map based on the first location and an identifier of the at least one first radio node or the reference signal strength is determined at least in part based on the first instance of radio observation data and a second instance of radio observation data of the plurality of instances of radio observation data, the second instance of radio observation data is associated with a second instance of location data indicating a second location located within a set distance of the first location, the second instance of radio observation data is associated with a second context that is different from the first context.

17. The apparatus of claim 14, wherein the at least one memory and the computer program code are further configured to, with the processor, cause the apparatus to at least determine a respective context for each instance of radio observation data of the plurality instances of radio observation data based on at least one of a respective circumstance parameter or a respective location indicated by a respective instance of location data.

18. The apparatus of claim 14, wherein the plurality of instances of radio observation data comprises a first group of consecutive instances of radio observation data that are associated with the first context and a second group of consecutive instances of radio observation data that are associated with a second context, the first signal strength correction is used to generate corrected signal strengths corresponding to the instances of radio observation data of the first group, and a second signal strength correction is determined and used to generate corrected signal strengths corresponding to the instances of radio observation data of the second group.

19. The apparatus of claim 14, wherein the first instance of radio observation data indicates respective first observed signal strengths for a first radio node and a second radio node, and at least one of:
when respective reference signal strengths at the first location are available for both the first radio node and the second radio node, the first signal strength correction is determined based on a combination of the respective first observed signal strengths and the respective reference signal strengths for both the first radio node and the second radio node,
when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node regardless of respective transmission frequencies or transmission channels of the first and second radio node, or
when a reference signal strength at the first location is available for the first radio node and is not available for the second radio node, the first signal strength correction is determined based on the first observed signal strength of the first radio node and the reference signal strength of the first radio node, and the first signal strength correction and the first observed signal strength for the second radio node are used to generate a corrected signal strength at the first location for the second radio node only when the first and second radio node are associated with a same transmission frequency or transmission channel.

20. The apparatus of claim 14, wherein when a second instance of radio observation data indicates a second observed signal strength of a second radio node and the second instance of radio observation data is associated with the first context, the first signal strength correction and the second observed signal strength are used to generate a corrected signal strength at a second location for the second radio node, the second location indicated by a second instance of location data associated with the second instance of radio observation data.
